(19) United States
(12) Patent Application Publication
(10) Pub. No.: US 2025/0013952 A1
(43) Pub. Date: Jan. 9, 2025

(54) TIME/DATE ADJUSTMENT APPARATUS, TIME/DATE ADJUSTMENT METHOD, AND STORAGE MEDIUM STORING PROGRAM

(71) Applicant: E4 Inc., Tokyo (JP)

(72) Inventor: Taichiro SUGIMOTO, Tokyo (JP)

(21) Appl. No.: 18/712,541

(22) PCT Filed: Sep. 29, 2022
(86) PCT No.: PCT/JP2022/036571

§ 371 Date: May 22, 2024

(30) Foreign Application Priority Data
Nov. 24, 2021 (JP) 2021-190048

(51) Int. Cl. G06Q 10/0631; G06Q 10/1093

(52) U.S. Cl. CPC G06Q 10/063116; G06Q 10/1095

(57) ABSTRACT

A time/date adjustment apparatus excludes an existing plan includes an exclusion keyword out of existing plans of a participant from plans that require participation, considers the rest of the existing plans as the plans that require participation, and determines time/dates on which the plans that require participation are not present as available time/dates of the participant. When an adjustment partner performs access, the time/date adjustment apparatus refers to schedule information of the participant managed by an external system to extract the available time/dates of the participant satisfying an adjustment condition as candidate time/dates, displays a time/date adjustment screen presenting the extracted candidate time/dates on a second terminal apparatus used by the adjustment partner, determines an assembly time/date out of the candidate time/dates in response to a selection operation of the adjustment partner, and registers the assembly time/date in the schedule information of the participant managed by the external system.

### TECHNICAL FIELD

The present invention relates to a time/date adjustment apparatus, a time/date adjustment method, and a program. The present invention claims priority based on Japanese Patent Application No. 2021-190048 filed on Nov. 24, 2021, the contents of which are incorporated herein by reference for designated states where incorporation of literature by reference is permitted.

### BACKGROUND ART

Conventionally, adjustment of a time/date (time and date) of an assembly in business requires a large number of steps such as checking of a schedule of each participant and securing a site, and is therefore considerably bothersome work taking time and efforts.

Note that, regarding checking of schedules of participants, it is considered that a calendar tool is referred to, as many businesspersons manage their plans using a calendar tool provided on the Internet in recent years.

Regarding the calendar tool, for example, PTL 1 provides the following description: “a schedule information sharing method including the steps of: performing membership application registration by each of a plurality of applicants and a plurality of users, the plurality of applicants applying for distribution of schedule information, the plurality of users using the schedule information of the distribution, the plurality of applicants and the plurality of users each being a member of a system that distributes and shares the schedule information via the Internet; executing by a scheduler performing schedule management below; disclosing and distributing, by the applicant, the schedule information to the user; registering, by the user, a target desiring distribution of the disclosed schedule information; and based on a registered desired distribution target of the user, synchronizing and presetting the schedule information related thereto to a calendar of all of user terminals.”

### CITATION LIST

### Patent Literature

PTL 1: JP 2019-219831 A

### SUMMARY OF INVENTION

### Technical Problem

In a technique described in PTL 1, a plurality of users being members of a system can share schedule information with each other, and use the schedule information for adjustment of a time/date of an assembly. However, even if the system is used, schedules of participants in a meeting or the like may be updated and changed from moment to moment. When a non-member of the system is included in the participants in the assembly, a schedule of the non-member needs to be individually checked, which makes it difficult to perform adjustment of a time/date of the assembly without causing an overlap between existing plans of each of the participants and a time/date on which the assembly is held, in other words, without causing a double booking.

Conventionally, the time/date on which the assembly is held is determined among available time/dates of participants. Although some participants are required to participate in an assembly (having a high priority) of which time/date is being adjusted, the time/date of the assembly having a high priority cannot be determined in some cases, due to presence of an existing plan having a lower priority (for example, an assembly that may allow absence depending on a situation, an assembly of which time/date is easily changed because of participation of only in-house members with a close relationship, a time/date that is secured as time for work of the person themselves, and the like) than the assembly.

The present invention is made in view of such circumstances as described above, and has an object to allow easy adjustment of a time/date of an assembly without causing a double booking with an existing plan having a high priority while permitting a double booking with an existing plan having a low priority.

### Solution to Problem

The present application includes a plurality of solutions to at least a part of the problems described above, examples of which are described as follows.

In order to solve the problems described above, a time/date adjustment apparatus according to one aspect of the present invention includes: an adjustment condition setting unit configured to set an adjustment condition related to an assembly; and a time/date adjustment unit configured to adjust an assembly time/date based on the adjustment condition, wherein the adjustment condition setting unit sets the adjustment condition including a participant and designation of an exclusion keyword in response to an input of an adjustment initiator, the time/date adjustment unit is configured to exclude an existing plan of which information related to the existing plan includes the exclusion keyword out of the existing plans of the participant in schedule information managed by an external system from plans that require participation, consider a rest of the existing plans as the plans that require participation, and determine time/dates on which the plans that require participation are not present as available time/dates of the participant, when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates, the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and the time/date adjustment unit registers the determined assembly time/date in the schedule information of the participant managed by the external system.

A time/date adjustment apparatus according to another aspect of the present invention includes: an adjustment condition setting unit configured to set an adjustment condition related to an assembly; and a time/date adjustment unit configured to adjust an assembly time/date based on the adjustment condition, wherein the adjustment condition setting unit sets the adjustment condition including a participant and designation of an exclusion plan in response to an input of an adjustment initiator, the time/date adjustment unit is configured to exclude an existing plan designated as the exclusion plan by the adjustment initiator out of the existing plans of the participant in schedule information managed by an external system from plans that require participation, consider a rest of the existing plans as the plans that require participation, and determine time/dates on which the plans that require participation are not present as available time/dates of the participant, when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates, the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and the time/date adjustment unit registers the determined assembly time/date in the schedule information of the participant managed by the external system.

The adjustment condition setting unit can set the adjustment condition including designation of time secured before and after, in response to the input of the adjustment initiator. The time/date adjustment unit can determine time/dates on which the plans that require participation are not present except the time secured before and after corresponding to the plans that require participation as the available time/dates of the participant.

The adjustment condition setting unit can cause the existing plan designated by the adjustment initiator out of a displayed list of the existing plans of the participant to be the exclusion plan.

The time/date adjustment unit can determine second candidate time/dates, in response to the input of the adjustment initiator for a time/date editing screen. The time/date adjustment unit can issue the access information. When the adjustment partner performs access based on the access information, the time/date adjustment unit can refer to the schedule information of the participant to extract third candidate time/dates that are the available time/dates of the participant satisfying the adjustment condition and are within a range of the second candidate time/dates. The time/date adjustment unit can display the time/date adjustment screen presenting the extracted third candidate time/dates on the second terminal apparatus, and determine the assembly time/date out of the third candidate time/dates in response to the selection operation of the adjustment partner for the time/date adjustment screen. The time/date adjustment unit can register the determined assembly time/date in the schedule information of the participant managed by the external system.

The time/date adjustment unit can refer to the schedule information of the participant managed by the external system to extract the available time/dates of the participant satisfying the adjustment condition as first candidate time/dates. The time/date adjustment unit can display the time/date editing screen for editing the extracted first candidate time/dates on a first terminal apparatus used by the adjustment initiator.

The adjustment condition setting unit can cause the existing plan of the participant designated by the adjustment initiator on the time/date editing screen to be the exclusion plan.

The adjustment condition setting unit can display a template creation screen for creating an adjustment condition template on a first terminal apparatus used by the adjustment initiator. The adjustment condition setting unit can register the adjustment condition template that can be repeatedly used for adjustment of time/dates of different assemblies and the access information corresponding to the adjustment condition template, in response to designation of the adjustment initiator for the template creation screen.

The participant can be the adjustment initiator themselves, or a belonging member belonging to an organization to which the adjustment initiator belongs.

When a plurality of the participants are designated as the adjustment condition, the time/date adjustment unit can refer to, in response to the adjustment partner performing access based on the access information, the schedule information of all of the plurality of the participants managed by the external system to extract the available time/dates common to all of the plurality of the participants satisfying the adjustment condition as the candidate time/dates.

When a plurality of the participants are designated as the adjustment condition, the time/date adjustment unit can refer to, in response to the adjustment partner performing access based on the access information, the schedule information of all of the plurality of the participants managed by the external system to extract the available time/dates of at least one of all of the plurality of the participants satisfying the adjustment condition as the candidate time/dates.

The adjustment condition setting unit can set the adjustment condition including a site to be used for the assembly, in response to the input of the adjustment initiator. When the adjustment partner performs access based on the access information, the time/date adjustment unit can refer to the schedule information of each of the participant and the site managed by the external system to extract the available time/dates common to the available time/dates of the participant satisfying the adjustment condition and the available time/dates of the site on which the existing plans of the site are not present as the candidate time/dates. The time/date adjustment unit can cause the second terminal apparatus to display the time/date adjustment screen presenting the extracted candidate time/dates, and determine the assembly time/date out of the candidate time/dates in response to the selection operation of the adjustment partner for the time/date adjustment screen. The time/date adjustment unit can register the determined assembly time/date in the schedule information of each of the participant and the site managed by the external system.

A time/date adjustment method according to yet another aspect of the present invention includes: an adjustment condition setting step of setting an adjustment condition related to an assembly; and a time/date adjustment step of adjusting an assembly time/date based on the adjustment condition, wherein the adjustment condition setting step includes setting the adjustment condition including a participant and designation of an exclusion keyword in response to an input of an adjustment initiator, the time/date adjustment step includes excluding an existing plan of which information related to the existing plan includes the exclusion keyword out of the existing plans of the participant in schedule information managed by an external system from plans that require participation, considering a rest of the existing plans as the plans that require participation, and determining time/dates on which the plans that require participation are not present as available time/dates of the participant, when an adjustment partner performs access based on access information notified to the adjustment partner by the adjustment initiator, the time/date adjustment step includes referring to the schedule information of the participant managed by the external system to extract the available time/dates of the participant satisfying the adjustment condition as candidate time/dates, the time/date adjustment step includes displaying a time/date adjustment screen presenting the extracted candidate time/dates on a second terminal apparatus used by the adjustment partner, and determining the assembly time/date out of the candidate time/dates in response to a selection operation of the adjustment partner for the time/date adjustment screen, and the time/date adjustment step includes registering the determined assembly time/date in the schedule information of the participant managed by the external system.

A program according to yet another aspect of the present invention causes a computer to function as: an adjustment condition setting unit configured to set an adjustment condition related to an assembly; and a time/date adjustment unit configured to adjust an assembly time/date based on the adjustment condition, wherein the adjustment condition setting unit sets the adjustment condition including a participant and designation of an exclusion keyword in response to an input of an adjustment initiator, the time/date adjustment unit is configured to exclude an existing plan of which information related to the existing plan includes the exclusion keyword out of the existing plans of the participant in schedule information managed by an external system from plans that require participation, consider a rest of the existing plans as the plans that require participation, and determine time/dates on which the plans that require participation are not present as available time/dates of the participant, when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates, the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and the time/date adjustment unit registers the determined assembly time/date in the schedule information of the participant managed by the external system.

A time/date adjustment method according to yet another aspect of the present invention includes: an adjustment condition setting step of setting an adjustment condition related to an assembly; and a time/date adjustment step of adjusting an assembly time/date based on the adjustment condition, wherein the adjustment condition setting step includes setting the adjustment condition including a participant and designation of an exclusion plan in response to an input of an adjustment initiator, the time/date adjustment step includes excluding an existing plan designated as the exclusion plan by the adjustment initiator out of the existing plans of the participant in schedule information managed by an external system from plans that require participation, considering a rest of the existing plans as the plans that require participation, and determining time/dates on which the plans that require participation are not present as available time/dates of the participant, when an adjustment partner performs access based on access information notified to the adjustment partner by the adjustment initiator, the time/date adjustment step includes referring to the schedule information of the participant managed by the external system to extract the available time/dates of the participant satisfying the adjustment condition as candidate time/dates, the time/date adjustment step includes displaying a time/date adjustment screen presenting the extracted candidate time/dates on a second terminal apparatus used by the adjustment partner, and determining the assembly time/date out of the candidate time/dates in response to a selection operation of the adjustment partner for the time/date adjustment screen, and the time/date adjustment step includes registering the determined assembly time/date in the schedule information of the participant managed by the external system.

A program according to yet another aspect of the present invention causes a computer to function as: an adjustment condition setting unit configured to set an adjustment condition related to an assembly; and a time/date adjustment unit configured to adjust an assembly time/date based on the adjustment condition, wherein the adjustment condition setting unit sets the adjustment condition including a participant and designation of an exclusion plan in response to an input of an adjustment initiator, the time/date adjustment unit is configured to exclude an existing plan designated as the exclusion plan by the adjustment initiator out of the existing plans of the participant in schedule information managed by an external system from plans that require participation, consider a rest of the existing plans as the plans that require participation, and determine time/dates on which the plans that require participation are not present as available time/dates of the participant, when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates, the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and the time/date adjustment unit registers the determined assembly time/date in the schedule information of the participant managed by the external system.

### Advantageous Effects of Invention

According to the present invention, a time/date of an assembly can be easily adjusted without causing a double booking with an existing plan having a high priority while permitting a double booking with an existing plan having a low priority.

Problems, configurations, and effects other than those described above will become apparent in the following description of embodiments.

### BRIEF DESCRIPTION OF DRAWINGS

FIG. 1 is a diagram illustrating a configuration example of a time/date adjustment system according to one embodiment of the present invention.

FIG. 2 is a diagram illustrating an example of each of member information, user information, adjustment condition template information, and time/date adjustment information.

FIG. 3 is a sequence diagram for illustrating an example of processing performed by the time/date adjustment system at the time of use registration.

FIG. 4 is a sequence diagram for illustrating an example of time/date adjustment processing performed by the time/date adjustment system.

FIG. 5 is a diagram illustrating a display example of a condition setting screen.

FIG. 6 is a diagram illustrating a display example of the condition setting screen.

FIG. 7 is a diagram illustrating a display example of an exclusion plan designation screen.

FIG. 8 is a diagram illustrating a display example of a time/date editing screen.

FIG. 9 is a diagram illustrating a display example of the time/date editing screen.

FIG. 10 is a diagram illustrating a display example of a time/date adjustment screen.

FIG. 11 is a diagram illustrating a display example of the time/date adjustment screen.

FIG. 12 is a diagram illustrating a display example of a time/date confirmation screen.

FIG. 13 is a diagram illustrating a display example of a time/date notification screen.

FIG. 14 is a sequence diagram for illustrating an example of adjustment condition template creation processing.

FIG. 15 is a diagram illustrating a display example of a template list screen.

FIG. 16 is a diagram illustrating a display example of a template creation screen.

FIG. 17 is a diagram illustrating a display example of the template creation screen.

FIG. 18 is a sequence diagram for illustrating another example of the time/date adjustment processing performed by the time/date adjustment system.

### DESCRIPTION OF EMBODIMENTS

One embodiment according to the present invention will be described below with reference to the drawings. Note that, in all the drawings for describing one embodiment, the same members are denoted by the same reference signs in principle, and repeated description thereof will be omitted. It goes without saying that, in the following embodiment, constituent elements (including element steps and the like) thereof are not necessarily essential, except for a case in which there is particular and explicit description, a case in which it is considered that those are obviously essential in principle, and the like. Concerning descriptions “to consist of A”, “to be composed of A”, “to have A”, and “to include A”, it goes without saying that, except for a case in which there is particular and explicit description that only the element is provided, and the like, elements other than the element are not to be excluded. Similarly, in the following embodiment, when there is a reference to a shape, a positional relationship, and the like of a constituent element and the like, a shape and the like that are substantially close to or similar to those shape and the like are included, except for a case in which there is particular and explicit description, a case in which it is considered that those are not obviously true in principle, and the like.

<Time/Date Adjustment System 10 according to One Embodiment of Present Invention>

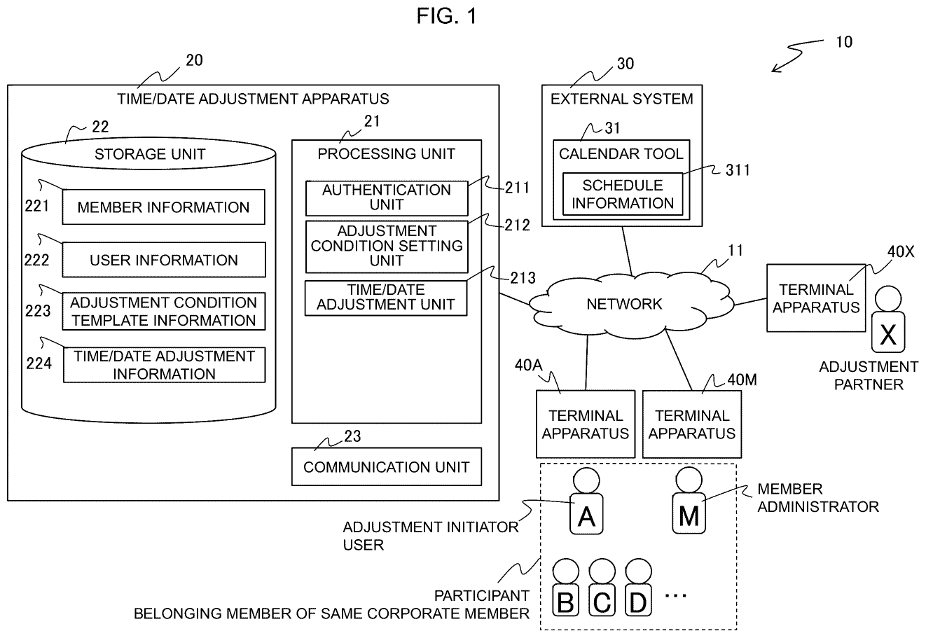

FIG. 1 illustrates a configuration example of a time/date adjustment system 10 according to one embodiment of the present invention.

The time/date adjustment system 10 is for assisting adjustment of a time/date of an assembly. The time/date adjustment system 10 includes a time/date adjustment apparatus 20, an external system 30, and terminal apparatuses 40A, 40M, and 40X, which are connected via a network 11.

The network 11 is a two-way communication network, as typified by the Internet, a mobile phone communication network, and the like.

The time/date adjustment apparatus 20 performs adjustment of a time/date of an assembly with an adjustment partner X, in response to a request from an adjustment initiator A. Note that, in the assembly, participation of the adjustment initiator A, belonging members B, C, and D and the like (including a member administrator M of an organization to which the adjustment initiator A belongs) of the organization to which the adjustment initiator A belongs (a company or the like; a corporate member to be described below), and the adjustment partner X is assumed. Note that, in this specification, among persons to actually participate in the assembly, the adjustment initiator A and the belonging members of the organization to which the adjustment initiator A belongs are defined as “participants” of the assembly, and the adjustment partner X to participate in the assembly is not included in the “participants” (not referred to as a “participant”).

The external system 30 refers to a system that widely provides a calendar tool 31 as a web application for general consumers, corporations, and the like with or without a charge. As the calendar tool 31, for example, Google Calendar (trademark) and Microsoft Outlook (trademark) can be employed. The calendar tool 31 stores schedule information 311, in which action plans of a user of the calendar tool 31 and a booking status of assembly sites available to the user are registered. In other words, the external system 30 manages schedule information 311, in which action plans of a user of the calendar tool 31 and a booking status of assembly sites available to the user are registered.

The terminal apparatus 40A used by the adjustment initiator A includes a general computer, such as a personal computer and a smartphone, that can connect to the time/date adjustment apparatus 20 via the network 11. Similarly, the terminal apparatus 40M used by the member administrator M and the terminal apparatus 40X used by the adjustment partner X each include a general computer. The terminal apparatus 40A corresponds to a first terminal apparatus of the present invention, and the terminal apparatus 40X corresponds to a second terminal apparatus of the present invention.

Note that, in the present embodiment, the adjustment partner X to participate in an assembly operates the terminal apparatus 40X; however, in actuality, a representative (a secretary or the like) of the adjustment partner X may operate the terminal apparatus 40X. The adjustment initiator A may select a plurality of participants out of the belonging members of the same organization (corporate member to be described below) as the adjustment initiator A, and the adjustment initiator A may perform adjustment of a time/date on behalf of the plurality of participants.

Moreover, in FIG. 1, only the adjustment partner X is illustrated as an adjustment partner to participate in a meeting; however, there may be a plurality of adjustment partners.

The adjustment initiator A is a belonging member of a company or the like that has conducted member registration and use registration (registration of information necessary for making a time/date adjustment function in the time/date adjustment apparatus 20 available) with the time/date adjustment apparatus 20. The company or the like that has conducted member registration with the time/date adjustment apparatus 20 is hereinafter referred to as a corporate member. Among belonging members belonging to the corporate member (company or the like), a belonging member having a user account of the time/date adjustment apparatus 20 is defined as a user. It is essential that the adjustment initiator A be a user. Thus, the adjustment initiator A may be hereinafter referred to as a user A. Note that an individual, not a company or the like, can also conduct use registration with the time/date adjustment apparatus 20. In that case, the individual who has conducted use registration is referred to as an individual member. The individual member and the user can be regarded as the same.

The belonging members B, C, and D and the like belonging to the same corporate member as the adjustment initiator A may be users, but this is not essential.

Belonging members belonging to the corporate member of the time/date adjustment apparatus 20 manage their plans, using the calendar tool 31 provided by the external system 30. The corporate member of the time/date adjustment apparatus 20 manages the booking status of a meeting room, a reception room, a spare room, and the like available to the belonging members as an assembly site, using the calendar tool 31 provided by the external system 30.

Thus, in the present case, the calendar tool 31 stores the schedule information 311 in which each of plans of the adjustment initiator A and the like who may be participants of an assembly and the booking status of assembly sites available to the adjustment initiator A and the like is registered.

Note that the adjustment partner X may be a user of the time/date adjustment apparatus 20, but this is not essential. The adjustment partner X may use the calendar tool 31, but this is not essential. The adjustment partner X may use a calendar tool provided by a vendor different from a vendor of the calendar tool 31 used by the adjustment initiator A.

The time/date adjustment apparatus 20 includes functional blocks of a processing unit 21, a storage unit 22, and a communication unit 23. The time/date adjustment apparatus 20 includes a general computer such as a server computer including a processor such as a central processing unit (CPU), a memory such as a dynamic random access memory (DRAM), a storage such as a hard disk drive (HDD) and a solid state drive (SSD), an input device such as a keyboard, a mouse, and a touch panel, an output device such as a display, and a communication module such as a network interface card (NIC) (all of which are not illustrated).

The processing unit 21 is implemented by the processor of the computer. The processing unit 21 includes functional blocks of an authentication unit 211, an adjustment condition setting unit 212, and a time/date adjustment unit 213. These functional blocks are implemented by the processor of the computer executing a predetermined program loaded in the memory. Note that a part or all of these functional blocks may be implemented as hardware by an integrated circuit or the like.

For example, the authentication unit 211 receives member registration performed by the member administrator M using the terminal apparatus 40M, and creates member information 221. For example, in response to a first login of a user performed by the adjustment initiator A using the terminal apparatus 40A, and when a predetermined condition is satisfied, the authentication unit 211 creates user information 222.

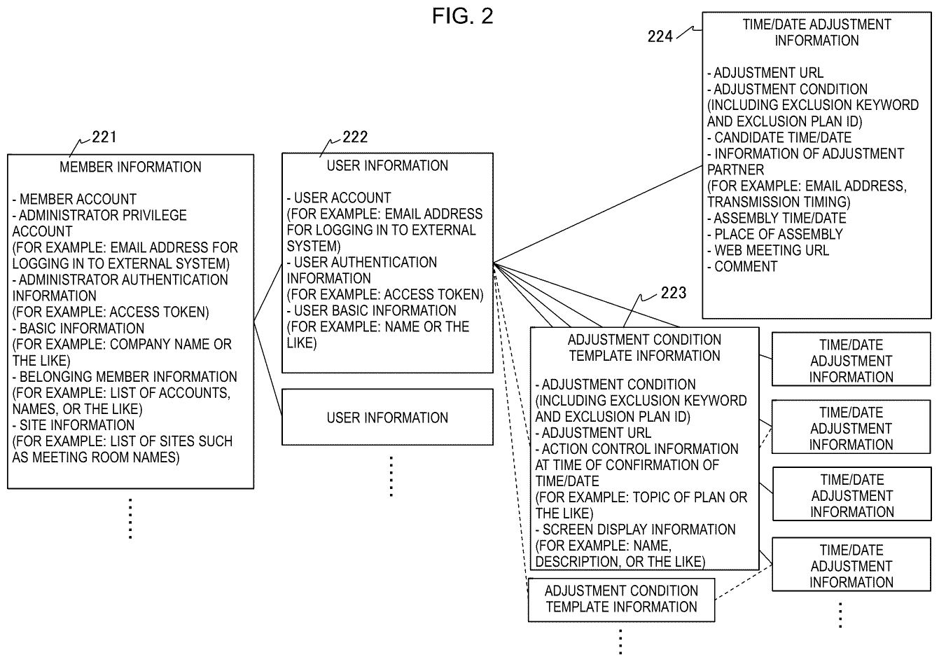

Moreover, the authentication unit 211 accesses the external system 30 via the network 11, and for example, performs authentication processing in accordance with a protocol such as OAuth, using an administrator privilege account included in the member information 221 and a user account included in the user information 222 corresponding to the adjustment initiator A (user A) (both in FIG. 2) stored in the storage unit 22. Note that the administrator privilege account and the user account may be used in first authentication processing, and in second and following authentication processing, administrator authentication information (an access token or the like) and user authentication information (an access token or the like) (both in FIG. 2) transmitted from the external system 30 after the first authentication processing has ended can be used.

The adjustment condition setting unit 212 causes the terminal apparatus 40A to display a condition setting screen for setting an adjustment condition including a plurality of items necessary for adjustment of a time/date of an assembly, sets the adjustment condition in response to an input from the adjustment initiator A on the condition setting screen, and registers results in time/date adjustment information 224 corresponding to the adjustment initiator A stored in the storage unit 22. The items of the adjustment condition will be described below.

The time/date adjustment unit 213 refers to the schedule information 311 of the participants (which may or may not include the adjustment initiator A) of the assembly being managed by the external system 30, and extracts available time/dates of the participants satisfying the set adjustment condition as first candidate time/dates.

Here, the available time/date of a participant in the present embodiment is a time/date on which it can be determined that a plan of a new assembly may be added as a result of taking account of whether or not an existing plan of the participant present in the schedule information 311 is a plan that requires participation.

As available time/date addition determination methods, when neither of a method of designating an exclusion keyword (details will be described below; hereinafter referred to as a first addition determination method) nor a method of designating an exclusion plan (details will be described below; hereinafter referred to as a second addition determination method) is adopted, it is considered that all of the existing plans of the participant are plans that require participation, and it is determined that the time/dates on which the plans that require participation of the participant are not present are the available time/dates of the participant.

When at least one of the first addition determination method and the second addition determination method is designated, a part of the existing plans of the participant is excluded from the plans that require participation, the rest of the existing plans are considered as plans that require participation of the participant, and it is determined that the time/dates on which the plans that require participation of the participant are not present are the available time/dates of the participant.

Specifically, when the first addition determination method is adopted and the second addition determination method is not adopted, the existing plans of the participant of which topics include the exclusion keyword designated by the adjustment initiator A are excluded from the plans that require participation, the rest of the existing plans are considered as plans that require participation of the participant, and it is determined that the time/dates on which the plans that require participation of the participant are not present are the available time/dates of the participant.

When the second addition determination method is adopted and the first addition determination method is not adopted, the existing plans of the participant designated as the exclusion plans by the adjustment initiator A are excluded from the plans that require participation, the rest of the existing plans are considered as plans that require participation of the participant, and it is determined that the time/dates on which the plans that require participation of the participant are not present are the available time/dates of the participant.

When both of the first and second addition determination methods are adopted, the existing plans of the participant of which topics include the exclusion keyword set by the adjustment initiator A and the existing plans of the participant designated as the exclusion plans by the adjustment initiator A are excluded from the plans that require participation, the rest of the existing plans are considered as plans that require participation of the participant, and it is determined that the time/dates on which the plans that require participation of the participant are not present are the available time/dates of the participant.

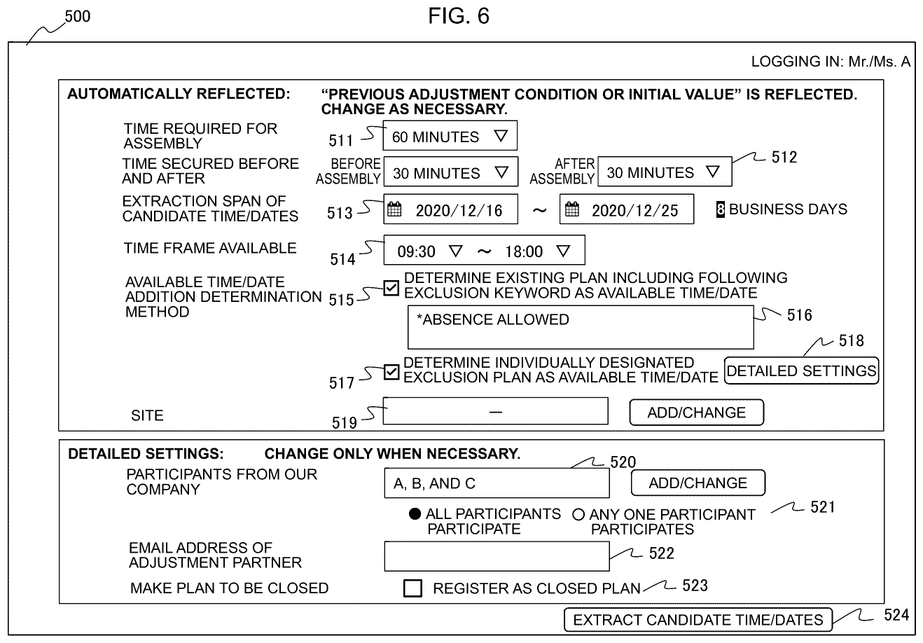

Note that the exclusion keyword can be input by the adjustment initiator A on a condition setting screen 500 (FIG. 6). As the exclusion keyword, for example, “*absence allowed”, “*time/date changeable”, and the like are assumed. In the company or the like of the corporate member, as an in-house rule, when the belonging member (the adjustment initiator A, the member administrator M, or the belonging members B, C, and D, and the like in the present embodiment) registers a plan with the calendar tool 31, and the priority of the plan is low and absence is allowed depending on a situation, registration is performed by including the exclusion keyword “*absence allowed” in the topic of the plan. For example, when the plan is a plan in which only in-house members with a close relationship participate and the time/date thereof can be easily changed, registration is performed by including the exclusion keyword “*time/date changeable” in the topic of the plan.

Note that, as the exclusion keyword, a specific symbol or letter may be adopted in addition to the text such as “*absence allowed” and “*time/date changeable”. Instead of or in addition to including the exclusion keyword in the topic of the plan, for example, the exclusion keyword may be registered in another field such as notes and a description (memo) of the plan. In this case, in the first addition determination method, whether or not the exclusion keyword is included in another field such as notes and a description (memo) of the plan in addition to the topic of the plan may even be determined.

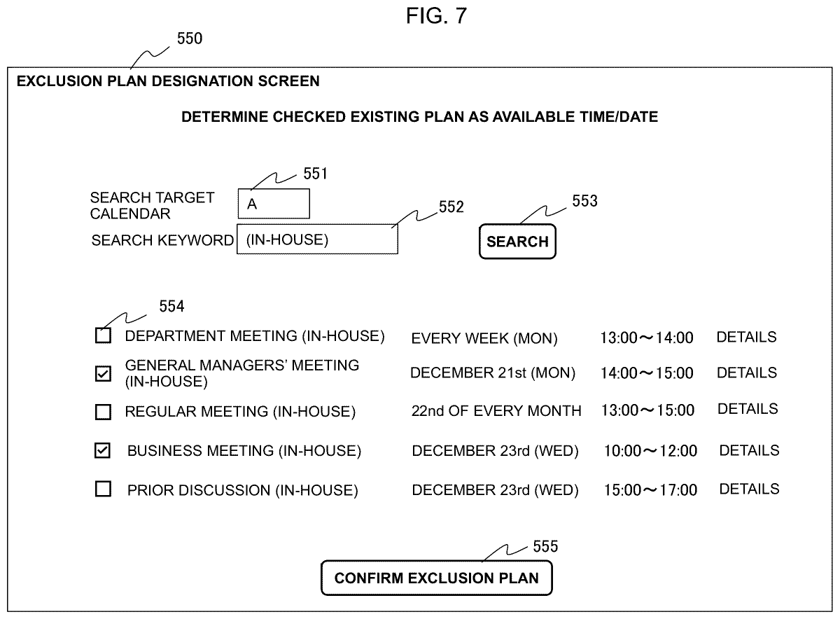

The exclusion plan can be designated by the adjustment initiator A on an exclusion plan designation screen 550 (FIG. 7). This will be described below in detail with reference to FIG. 7.

After extracting the first candidate time/dates, the time/date adjustment unit 213 causes the terminal apparatus 40A to display a time/date editing screen for editing the first candidate time/dates, and determines second candidate time/dates in response to an editing operation from the adjustment initiator A on the time/date editing screen. The second candidate time/dates are registered in the time/date adjustment information 224 corresponding to the adjustment initiator A. When the first candidate time/dates are not edited by the adjustment initiator A, the first candidate time/dates and the second candidate time/dates are the same.

Note that, as a modification, instead of determining the second candidate time/dates by editing the first candidate time/dates, extraction of the first candidate time/dates may be omitted, and for example, the adjustment initiator A may select dates and time and thereby determine the second candidate time/dates in the calendar on a predetermined screen that the time/date adjustment unit 213 causes the terminal apparatus 40A to display.

The time/date adjustment unit 213 issues an adjustment Uniform Resource Locator (URL) for the adjustment partner X to access a time/date adjustment screen. Note that, without the time/date adjustment unit 213 issuing the adjustment URL, the adjustment initiator A may designate the adjustment URL (details will be described below). The adjustment URL may be issued as text, or may be issued as an image such as a QR code. The issued adjustment URL is transmitted to the adjustment partner X by the adjustment initiator A, using an electronic mail or the like. The adjustment URL corresponds to access information of the present invention.

Moreover, when the adjustment partner X accesses the adjustment URL by using the terminal apparatus 40X, at that time point, the time/date adjustment unit 213 refers to the schedule information 311 of the participants being managed by the external system 30 again, and extracts third candidate time/dates that are available time/dates of the participants satisfying the set adjustment condition and are within a range of the second candidate time/dates. Then, the time/date adjustment unit 213 causes the terminal apparatus 40X to display the time/date adjustment screen presenting the third candidate time/dates.

By extracting the third candidate time/dates, even if there is a change in the schedule of the participants during time from when the adjustment URL is issued to when the adjustment partner X accesses the adjustment URL, occurrence of a double booking due to such a change can be suppressed.

Furthermore, the adjustment partner X selects an assembly time/date out of the third candidate time/dates displayed on the time/date adjustment screen, and the time/date adjustment unit 213 registers the assembly time/date confirmed on a time/date confirmation screen in the schedule information 311 of the participants being managed by the external system 30, and registers results in the time/date adjustment information 224 corresponding to the adjustment initiator A stored in the storage unit 22. Note that the schedule of the participants may change even during a short period of time until the adjustment partner X selects the assembly time/date out of the third candidate time/dates displayed on the time/date adjustment screen and confirms the assembly time/date on the time/date confirmation screen. Thus, the time/date adjustment unit 213 may perform final check that the selected assembly time/date is an available time/date of the participants satisfying the adjustment condition, immediately before the assembly time/date is confirmed on the time/date confirmation screen. Then, if the selected assembly time/date is no longer an available time/date of the participants satisfying the adjustment condition, for example, a message such as “The designated time has been occupied. Select again” may be displayed on the terminal apparatus 40X, and the operation may be returned back to the time/date adjustment screen. With this configuration, occurrence of a double booking can be further suppressed.

The storage unit 22 is implemented by the memory and the storage of the computer. The storage unit 22 stores the member information 221, the user information 222, adjustment condition template information 223, and the time/date adjustment information 224. Note that the storage unit 22 may store information, data, and the like other than the various pieces of information described above.

The communication unit 23 is implemented by the communication module of the computer. The communication unit 23 connects to the external system 30, the terminal apparatuses 40A, 40M, and 40X, and the like via the network 11 and communicates various pieces of data and information therewith.

Note that a part or all of the above-described functional blocks constituting the time/date adjustment apparatus 20 may be implemented by hardware such as an integrated circuit. The time/date adjustment apparatus 20 may be implemented by a plurality of computers, and in that case, the above-described functional blocks may be distributedly deployed in the plurality of computers.

Next, FIG. 2 illustrates an example of the member information 221, the user information 222, the adjustment condition template information 223, and the time/date adjustment information 224 stored in the storage unit 22.

The member information 221 includes information related to a corporate member that has conducted member registration with the time/date adjustment apparatus 20. The member information 221 includes information related to a corporate member to be added through use registration of the corporate member with the time/date adjustment apparatus 20. Specifically, the member information 221 includes a member account, an administrator privilege account, administrator authentication information, basic information, belonging member information, and site information.

The member account is information for the member administrator M or the like of the corporate member (company or the like) to log in to the time/date adjustment apparatus 20. The administrator privilege account is information for the member administrator M or the like of the corporate member (company or the like) to access the external system 30 by using the administrator privileges. Note that the member account is desirably common to, but may be different from, the administrator privilege account (for example, an email address of the member administrator M or the like). When the member account and the administrator privilege account are common to each other, registration of the administrator privilege account with the member information 221 may be omitted.

The administrator authentication information is an access token or the like that is obtained from the external system 30 as success results of the authentication processing when the authentication unit 211 of the time/date adjustment apparatus 20 performs the authentication processing with the external system 30 for the first time, using the administrator privilege account. After the administrator authentication information is obtained, the authentication unit 211 can more promptly perform the authentication processing with the external system 30 by using the administrator authentication information, without using the administrator privilege account.

The basic information is a name of the corporate member (a company name or the like) or the like. The basic information is recorded at the time of member registration, and can also be changed after the member registration. The belonging member information is a list of names of belonging members belonging to the corporate member (company or the like), user accounts for accessing the external system 30, and the like. The belonging member information is acquired from the external system 30 and then recorded on an assumption that the belonging members of the corporate member who may be participants on the adjustment initiator A side already use the calendar tool 31.

The site information is a list of names of sites, such as a meeting room, a reception room, and a spare room, available to the belonging members belonging to the corporate member for an assembly, identification IDs of the sites in the external system, and the like. The site information is acquired from the external system 30 and then recorded on an assumption that the schedules of all of the sites necessary for time/date adjustment are already managed by the calendar tool 31.

Note that the belonging member information and the site information are information that can be partially or entirely acquired from the external system 30 only when the external system 30 is accessed using the administrator privilege account, and cannot be acquired (it is to be noted that the information can be partially acquired in some cases) when an account not having the administrator privileges is used instead of the administrator privilege account or when the external system 30 is accessed using an account that has privileges equivalent to the administrator privilege account but is used as a user account, for example.

The user information 222 includes information related to a user who has conducted use registration of the time/date adjustment apparatus 20 among the belonging members belonging to the corporate member. The user information 222 is created when each user logs in to the time/date adjustment apparatus 20 for the first time, succeeds in the authentication processing with the external system 30, and it is confirmed that the user is included in the belonging member information of the member information 221, and is then associated with the member information 221.

The user information 222 includes a user account, user authentication information, and user basic information.

The user account is information for the user, such as the adjustment initiator A, to log in to the time/date adjustment apparatus 20. The user account is desirably common to, but may be different from, an account for the user to access the external system 30. The following description will be given based on an assumption that the user account is common to an account for accessing the external system 30.

The user authentication information is an access token or the like that is obtained from the external system 30 as success results of the authentication processing when the authentication unit 211 performs the authentication processing with the external system 30 for the first time, using the user account. After the user authentication information is obtained, the authentication unit 211 can more promptly perform the authentication processing with the external system 30, using the user authentication information, without using the user account.

The user basic information is a name of the user or the like, and is read from the belonging member information of the member information 221 based on the user account used by the user in logging in to the time/date adjustment apparatus 20 for the first time, and is then recorded. The user basic information recorded in the user information 222 may be able to be edited by the user themselves.

The adjustment condition template information 223 includes an adjustment condition (which may include, but not necessarily require, an exclusion keyword and an exclusion plan ID), an adjustment URL, action control information (a topic and the like of a plan to be registered in the schedule information 311 of the participant or the like) at the time of confirmation of a time/date, and screen display information (a name (for example, “for a first interview for recruitment of a new graduate” and the like), a description, and the like of an adjustment condition template), which are designated by the user in advance depending on a purpose of the assembly.

Note that the adjustment condition template information 223 is created by the user and is thus associated with the user information 222; however, for example, the adjustment condition template information 223 may be associated with the member information 221, such that the adjustment condition template information 223 may be shared between users belonging to the corporate member corresponding to the member information 221. An adjustment condition template created by one user may be used by another user.

The time/date adjustment information 224 is created in association with the user information 222 corresponding to each user for each assembly in which the user is the adjustment initiator. Note that, considering that a user different from the user who has created the adjustment condition template adjusts a time/date using the adjustment condition template, the time/date adjustment information 224 may be directly associated with the member information 221 of a corporate member to which the user belongs.

In the time/date adjustment information 224, the adjustment URL, the adjustment condition (which may include, but not necessarily require, the exclusion keyword and the exclusion plan ID), the candidate time/dates (second candidate time/dates and the like), information (an email address, a timing of transmitting a notification email, and the like) of the adjustment partner, a confirmed date and time and place (in a case of a Web meeting, a Web meeting URL) of the assembly, a comment, and the like are recorded.

### <Processing Performed by Time/Date Adjustment System 10 at Time of Use Registration>

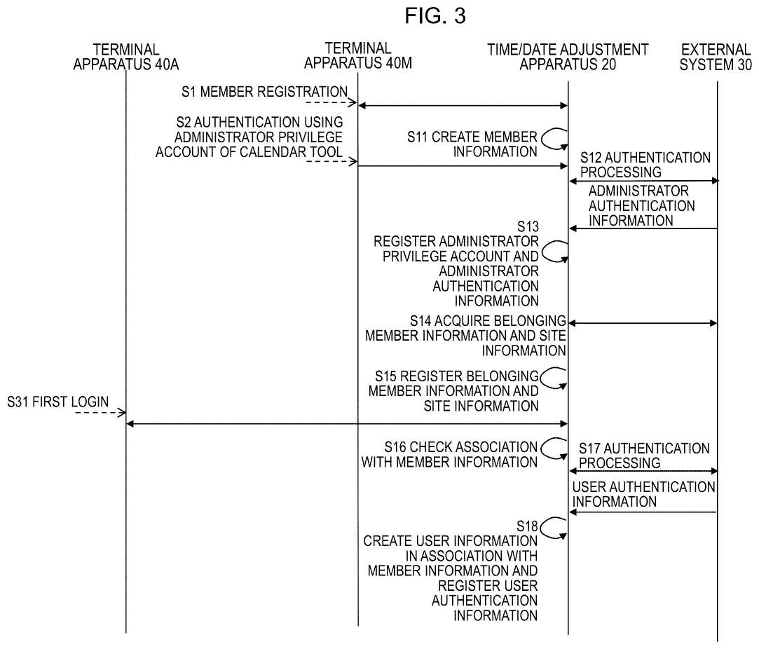

Next, FIG. 3 is a sequence diagram for illustrating an example of processing performed by the time/date adjustment system 10 at the time of use registration.

As an assumption, the calendar tool 31 provided by the external system 30 is used for management of plans of the belonging members of the corporate member to which the adjustment initiator A and the member administrator M belong and availability of the assembly sites of the corporate member, and the external system 30 already manages the belonging member information and the site information recorded in the member information 221. Further, the external system 30 supplies, as its specifications, at least one of the belonging member information and the site information recorded in the member information 221 to the time/date adjustment apparatus 20, in response to a request from the time/date adjustment apparatus 20 accessed using the administrator privilege account (or the administrator authentication information).

First of all, when the member administrator M requests member registration with the time/date adjustment apparatus 20 via the network 11 by using the terminal apparatus 40M (Step S1), the authentication unit 211 of the time/date adjustment apparatus 20 creates the member information 221 and records the member information 221 in the storage unit 22 (Step S11). Note that, here, the created member information 221 includes only the member account and the basic information, and does not include the administrator privilege account, the administrator authentication information, the belonging member information, and the site information.

Next, when the member administrator M inputs the administrator privilege account for the external system 30 and requests the authentication processing with the time/date adjustment apparatus 20 (Step S2), next, the authentication unit 211 performs the authentication processing with the external system 30, using the administrator privilege account (Step S12).

Note that, as a modification, Steps S1 and S11 may be executed after execution of Steps S2 and S12.

Then, the administrator authentication information (access token or the like) is transmitted from the external system 30 to the time/date adjustment apparatus 20 as success results of the authentication processing of Step S12, and thus, next, the authentication unit 211 registers the administrator privilege account and the administrator authentication information in the member information 221 created and recorded in Step S11 (Step S13). Note that, for the authentication processing, OAuth can be used, for example, and by having the member administrator M input a password to the external system 30 temporarily without using the authentication unit 211, the administrator privilege account input by the member administrator M is authenticated by the external system 30. The same holds true for the authentication processing performed by other persons such as the adjustment initiator A.

Next, the authentication unit 211 connects to the external system 30 by using the administrator authentication information of the member information 221, and acquires the belonging member information and the site information of the corporate member to which the member administrator M belongs, which are managed by the external system 30 (Step S14). Next, the authentication unit 211 registers the belonging member information and the site information acquired in Step S14 in the member information 221 created and recorded in Step S11 (Step S15).

Subsequently, when the adjustment initiator A uses the user account of the adjustment initiator A and logs in to the time/date adjustment apparatus 20 via the network 11 for the first time, using the terminal apparatus 40A (Step S31), the authentication unit 211 of the time/date adjustment apparatus 20 checks presence of the member information 221 in which the belonging member information including the user account of the adjustment initiator A is registered, and acquires the name (user basic information) of the adjustment initiator A from the belonging member information (Step S16). Next, the authentication unit 211 performs the authentication processing with the external system 30, using the user account of the adjustment initiator A (Step S17).

Then, the user authentication information (access token or the like) is transmitted from the external system 30 to the time/date adjustment apparatus 20 as success results of the authentication processing of Step S17, and thus, next, the authentication unit 211 creates the user information 222 corresponding to the adjustment initiator A, records the user information 222 in the storage unit 22 in association with the member information 221 checked in Step S16, and registers the user account and the user authentication information of the adjustment initiator A and the user basic information acquired in Step S16 in the user information 222 (Step S18). Through the above processing, the processing at the time of use registration ends.

According to the processing at the time of use registration described above, the member information 221 of the corporate member to which the adjustment initiator A belongs and the user information 222 of the adjustment initiator A are associated with each other. Thus, after the processing, even if the member administrator M is not logged in to the time/date adjustment apparatus 20, on the condition that the adjustment initiator A being a user is logged in to the time/date adjustment apparatus 20, for example, the time/date adjustment unit 213 of the time/date adjustment apparatus 20 can refer to and update the schedule information 311 in which plans of the adjustment initiator A and the belonging members B, C, and D and the like belonging to the same corporate member as the adjustment initiator A are registered and the schedule information 311 in which plans of assembly sites (a meeting room and the like) available to the adjustment initiator A and the belonging members B, C, and D and the like belonging to the same corporate member as the adjustment initiator A are registered, which are stored in the external system 30, via a web application programming interface (API).

Note that, in the processing at the time of use registration described above, the user information of the user belonging to the corporate member is generated, on an assumption that the member information 221 of the corporate member is present. As a modification, when an organization to which a certain individual belongs is not the corporate member and the member information 221 thereof is thus not present, the certain individual may log in to the time/date adjustment apparatus 20 and create the user information 222, and the individual may subsequently perform anew the authentication processing with the external system 30 by using the administrator privilege account, and the member information 221 associated with the individual may be thereby generated based on the user information 222 of the individual, with the individual being regarded as the corporate member and a user account of the individual being regarded as a member account. In this case, the individual as the corporate member has the administrator privilege account, and can thus acquire the belonging member information and the site information of the organization to which the individual belongs from the external system 30.

In the present embodiment, the belonging member information and the site information acquired from the external system 30 are registered in the member information 221 stored in the storage unit 22; however, without the belonging member information and the site information being registered in the member information 221, the belonging member information and the site information may be acquired from the external system 30 every time the pieces of information need to be referred to.

In the present embodiment, the belonging member information and the site information are acquired using the administrator privilege account on the external system 30; however, when it is difficult to use the administrator privilege account of the external system 30 from the perspective of security and the like, the belonging member information and the site information may be registered with the time/date adjustment apparatus 20 without using the administrator privilege account on the external system 30. For example, the member administrator M or the user of the corporate member may directly register the belonging member information and the site information with the time/date adjustment apparatus 20 by uploading data recording the belonging member information and the site information with the time/date adjustment apparatus 20, directly inputting the data on a screen for use registration displayed on the terminal apparatus 40M or the terminal apparatus 40A by the time/date adjustment apparatus 20, or the like. By using the user account privileges of the member administrator M or the user of the corporate member without using the administrator privilege account, only the belonging member information and the site information that can be acquired from the external system 30 may be acquired from the external system 30 and registered with the time/date adjustment apparatus 20.

### <Time/Date Adjustment Processing Performed by Time/Date Adjustment System 10>

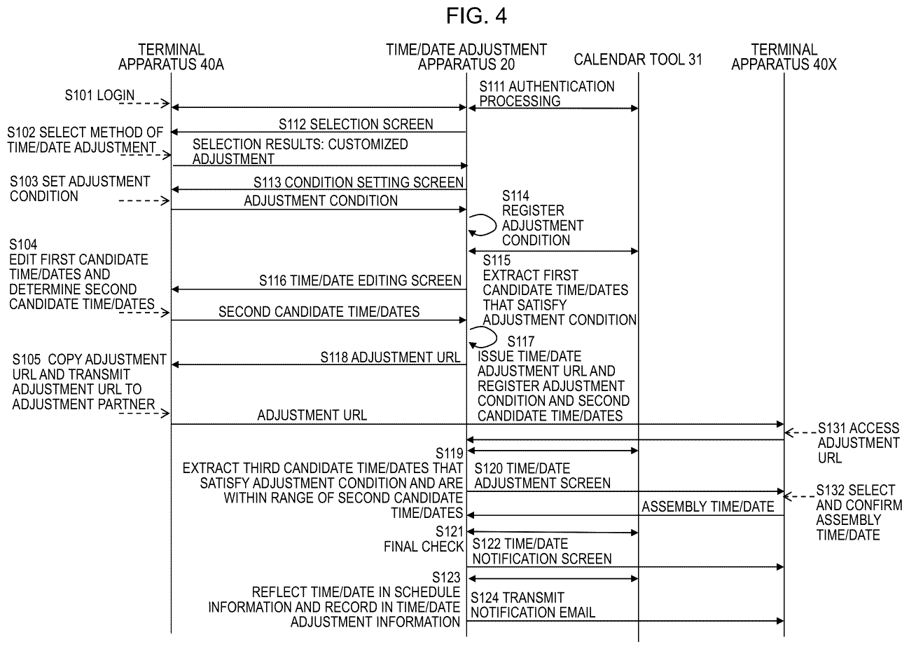

Next, FIG. 4 is a sequence diagram for illustrating an example of time/date adjustment processing performed by the time/date adjustment system 10.

First of all, the adjustment initiator A logs in to the time/date adjustment apparatus 20 via the network 11, using the terminal apparatus 40A (Step S101). Then, in response to the login of the adjustment initiator A, the authentication unit 211 of the time/date adjustment apparatus 20 performs the authentication processing with the external system 30, using the user account (or the user authentication information) included in the user information 222 corresponding to the adjustment initiator A stored by the storage unit 22 (Step S111).

Next, the adjustment condition setting unit 212 of the time/date adjustment apparatus 20 causes the terminal apparatus 40A to display a selection screen (not illustrated) for selecting either “customized adjustment” or “use template” as a method of time/date adjustment (Step S112). Next, on the selection screen, the adjustment initiator A selects the method of time/date adjustment (Step S102). In the present case, description will be given based on an assumption that the adjustment initiator A selects customized adjustment.

<Case in which “Customized Adjustment” Is Selected as Method of Time/Date Adjustment>

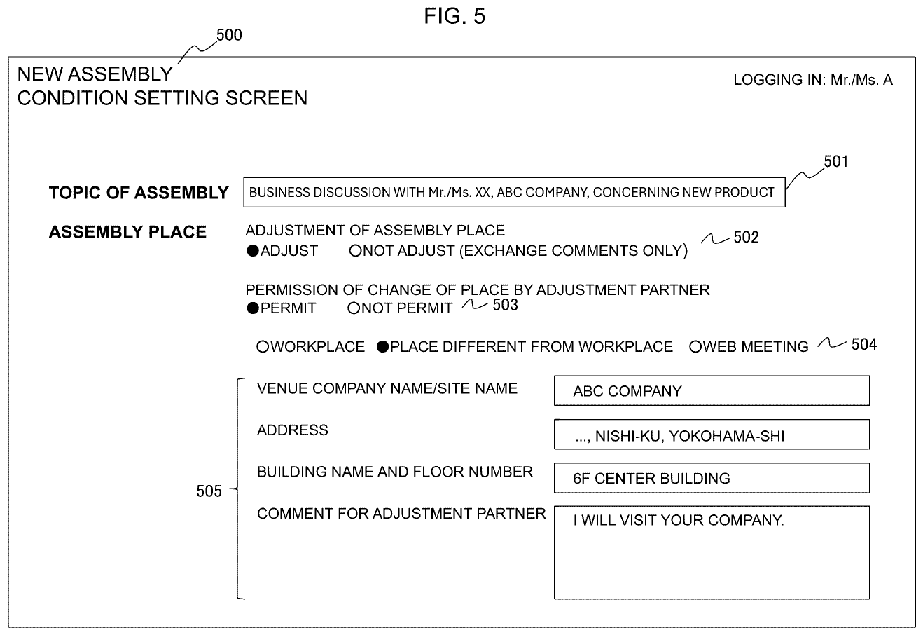

Next, the adjustment condition setting unit 212 of the time/date adjustment apparatus 20 causes the terminal apparatus 40A to display the condition setting screen 500 (FIG. 5 and FIG. 6) for setting the adjustment condition (which may include, but not necessarily require, the exclusion keyword and the exclusion plan) (Step S113).

FIG. 5 and FIG. 6 are display examples of the condition setting screen 500 displayed in the terminal apparatus 40A. FIG. 5 illustrates an upper part of the condition setting screen 500, and FIG. 6 illustrates a lower part of the condition setting screen 500, which is displayed by scrolling down the upper part illustrated in FIG. 5.

As illustrated in FIG. 5, the condition setting screen 500 is provided with an input field 501 for inputting an assembly topic, a radio button 502 for selecting whether or not to adjust an assembly place, a radio button 503 for selecting whether or not to permit change of the designated assembly place by the adjustment partner, a radio button 504 for selecting a workplace, a place different from the workplace, or a web meeting as the assembly place, and an input field 505 for inputting a name, an address, and the like of the assembly place.

Note that the input field 505 is provided when “workplace” or “place different from workplace” is selected in the radio button 504. When “web meeting” is selected in the radio button 504, a radio button (not illustrated) for selecting a videotelephony application as a method (means) of the assembly to be used for the web meeting is provided instead of the input field 505. When “not adjust” is selected in the radio button 502, only a comment input field (not illustrated) is provided instead of the radio buttons 503 and 504 and the input field 505.

Moreover, as illustrated in FIG. 6, the condition setting screen 500 is provided with a selection input field 511 for inputting time required for the assembly, a selection input field 512 for inputting time secured before and after the assembly, a selection input field 513 for inputting an extraction span of the candidate time/dates with a date, month, and year, a selection input field 514 for inputting a time frame available for the assembly, a check box 515 for instructing adopting the first addition determination method (the method of designating the exclusion keyword) as the available time/date addition determination method, an input field 516 for inputting the exclusion keyword when the check box 515 is checked (when the first addition determination method is adopted), a check box 517 for instructing adopting the second addition determination method (the method of individually designating the exclusion plan) as the available time/date addition determination method, a detail setting button 518 for transitioning to the exclusion plan designation screen 550 (FIG. 7) for designating the exclusion plan when the check box 517 is checked (when the second addition determination method is adopted), and a selection input field 519 for selecting and designating one or more rooms as the site to be used for the assembly out of a site list based on the site information of the member information 221.

Here, the time secured before and after the assembly to be input to the selection input field 512 is time for movement to the site, preparation work, withdrawal work, a break, and the like. When the time secured before and after the assembly is set, the time secured before and after the assembly needs to be reflected for the available time/dates of the participant. Specifically, for example, when a plan that requires participation of the participant is present at 12:00 to 13:00, and the time secured before is set to 30 minutes and the time secured after is set to 60 minutes, 11:00 to 13:30, which is a time frame combining three time frames, i.e., 11:00 to 12:00 as the time secured after the assembly, 12:00 to 13:00 for the plan that requires participation, and 13:00 to 13:30 as the time secured before the assembly, is a time/date in which plans of other assemblies cannot be made, and time/dates other than these are available time/dates of the participant.

To the selection input field 514, a different time frame available for the assembly can be input for each day of the week and for each national holiday.

When the check box 515 is checked, in other words, when the first addition determination method is adopted, one or more exclusion keywords are required to be input to the input field 516, and available time/date addition determination using the exclusion keyword(s) input to the input field 516 is performed. To the input field 516, for example, a plurality of exclusion keywords can be input by separating them using a line break, a comma “,”, or the like. Note that, when a plurality of exclusion keywords are input, existing plans of which topics include one or more exclusion keywords out of the plurality of input exclusion keywords are excluded from the plans that require participation.

The detail setting button 518 can be operated when the check box 517 is checked, in other words, when the second addition determination method is adopted. When the detail setting button 518 is operated, a screen transitions to the exclusion plan designation screen 550 (FIG. 7), and available time/date addition determination is performed with the designated exclusion plan. Note that, when the check box 517 is checked, one or more exclusion plans are required to be designated on the exclusion plan designation screen 550.

FIG. 7 illustrates a display example of the exclusion plan designation screen 550. The exclusion plan designation screen 550 is a screen for the adjustment initiator A to designate the exclusion plans that are not regarded as the plans that require participation out of the existing plans. The exclusion plan designation screen 550 is provided with an input field 551 for designating a calendar (schedule information 311) as a search target of the existing plans, an input field 552 for inputting a search keyword for narrowing down the existing plans, a search button 553 for instructing start of the search for the existing plans, and a confirm exclusion plan button 555 for confirming a designated existing plan out of the listed existing plans as the exclusion plan.

In the input field 551, the calendar as the search target can be designated through designation out of calendars present in the calendar tool 31. In the input field 552, for example, a plurality of search keywords can be input by separating them using a line break, a comma “,”, or the like, and when a plurality of search keywords are input, existing plans in the extraction span of the candidate time/dates of which topics include one or more search keyword(s) out of the plurality of input search keywords are searched for. The search keyword need not be input to the input field 552. In this case, narrowing down using the search keyword is not performed, and all of the existing plans that satisfy the extraction span of the candidate time/dates are searched for in the calendar as the search target designated in the input field 551.

When the adjustment initiator A designates the calendar as the search target in the input field 551, inputs the search keyword in the input field 552, and operates the search button 553, existing plans of which topics include the search keyword are searched for in the existing plans registered in the calendar as the search target. Note that, instead of or in addition to the topics of the existing plans, for example, existing plans of which other field such as notes and a description (memo) of the existing plans include the search keyword may be searched for. Then, a list of the searched existing plans is displayed on the exclusion plan designation screen 550.

Each of the listed existing plans is provided with a check box 554. The adjustment initiator A can check and thereby designate the check box 554 of any existing plan out of the existing plans listed on the exclusion plan designation screen 550 and operate the confirm exclusion plan button 555, and thereby confirm the designated existing plan as the exclusion plan.

For example, as illustrated in the drawing, when the adjustment initiator A designates the calendar of the adjustment initiator A themselves (participant A) in the input field 551 as the search target, inputs the search keyword “(in-house)” in the input field 552, and operates the search button 553, the adjustment condition setting unit 212 refers to the calendar (schedule information 311) of the participant A being managed by the external system 30 to search for the existing plans in the extraction span of the candidate time/dates of which topics include the search keyword “(in-house)” out of the existing plans of the participant A in the extraction span of the candidate time/dates, and displays a list thereof on the exclusion plan designation screen 550. Then, when the adjustment initiator A designates two out of five listed existing plans, i.e., “general managers' meeting (in-house)” at 14:00 to 15:00 on December 21st (Monday) and “sales meeting (in-house)” at 10:00 to 12:00 on December 23rd (Wednesday), and operates the confirm exclusion plan button 555, the two designated existing plans are confirmed as the exclusion plans, and the adjustment condition setting unit 212 records plan IDs on the calendar tool 31 related to the two confirmed exclusion plans as the exclusion plan IDs in the time/date adjustment information 224.

Note that, although a repeated plan (department meeting on every Monday and the like) is collectively displayed in a row in the drawing, whether the repeated plan is collectively displayed or individual plans included in the repeated plan are displayed in separate rows can be selected. When a repeated plan is collectively displayed and the check box 554 corresponding to the repeated plan is checked, individual plans included in the repeated plan may be additionally displayed with a check box, and each individual plan can be designated as the exclusion plan for each plan.

FIG. 6 is referred to again. Regarding the available time/dates of the participant, when the check boxes 515 and 517 are not checked, in other words, when neither of the first and second addition determination methods is adopted, the time/date adjustment unit 213 considers all of the existing plans of the participant as plans that require participation, and determines the time/dates on which the plans that require participation of the participant are not present except the time secured before and after corresponding to the plans that require participation of the participant as the available time/dates of the participant.

When the check box 515 is checked and the check box 517 is not checked, in other words, when the first addition determination method is adopted and the second addition determination method is not adopted, the time/date adjustment unit 213 excludes the existing plans of the participant of which topics include the exclusion keyword from the plans that require participation, considers the rest of the existing plans as plans that require participation of the participant, and determines the time/dates on which the plans that require participation of the participant are not present except the time secured before and after corresponding to the plans that require participation of the participant as the available time/dates of the participant.

When the check box 515 is not checked and the check box 517 is checked, in other words, when the first addition determination method is not adopted and the second addition determination method is adopted, the time/date adjustment unit 213 excludes the existing plans of the participant designated as the exclusion plans from the plans that require participation, considers the rest of the existing plans as plans that require participation of the participant, and determines the time/dates on which the plans that require participation of the participant are not present except the time secured before and after corresponding to the plans that require participation of the participant as the available time/dates of the participant.

When both of the check boxes 515 and 517 are checked, in other words, when both of the first and second addition determination methods are adopted, the time/date adjustment unit 213 excludes the existing plans of the participant of which topics include the exclusion keyword and the existing plans of the participant designated as the exclusion plans from the plans that require participation, considers the rest of the existing plans as plans that require participation of the participant, and determines the time/dates on which the plans that require participation of the participant are not present except the time secured before and after corresponding to the plans that require participation of the participant as the available time/dates of the participant.

Note that, in the selection input fields 511 to 514 and 519, the check boxes 515 and 517, and the input field 516, contents of the adjustment condition of the most recent assembly where the adjustment initiator A is an adjustment initiator are reflected with reference to the time/date adjustment information 224 associated with the user information 222 corresponding to the adjustment initiator A. With this configuration, time and efforts taken by the adjustment initiator A to input the adjustment condition can be reduced. Note that whether or not to allow automatic reflection of the adjustment condition of the most recent assembly in the selection input field 511 and the like may be selected by designation of the adjustment initiator A. One or more patterns for adjustment conditions may be registered in advance, so that when one of the patterns is designated and invoked, a corresponding adjustment condition can be simply reflected. The adjustment condition (information other than the extraction span of the candidate time/dates) of the adjustment condition template information 223 already registered may be copied, so that the adjustment condition can be simply reflected.

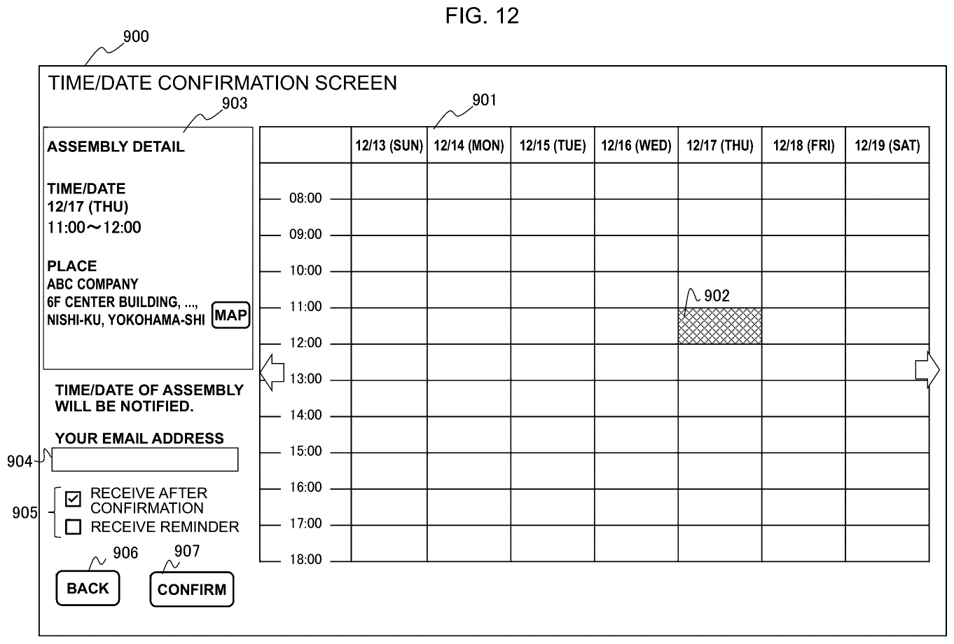

Furthermore, the condition setting screen 500 is provided with a selection input field 520 for selecting and designating one or more participants on the adjustment initiator A side (which may or may not include the adjustment initiator A) out of a belonging member list based on the belonging member information of the member information 221, a radio button 521 for selecting an assembly participation condition of the participant(s) designated in the selection input field 520, an input field 522 for omitting input of an email address by the adjustment partner X on a time/date confirmation screen 900 (FIG. 12), a check box 523 for selecting whether or not to register the plan of the assembly as a closed plan, and an extract candidate time/date button 524 for confirming each input item and instructing extraction of candidate time/dates of the assembly.

Note that, when a plurality of participants are designated in the selection input field 520 and all of the designated participants need to participate in the assembly, “all participants participate” may be selected in the radio button 521. When a plurality of participants are designated in the selection input field 520 and it is sufficient that at least one of the designated participants participates, “any one participant participates” may be selected in the radio button 521. When only one participant is input in the selection input field 520, “all participants participate” is automatically selected in the radio button 521, whereas when there is only one participant, subsequent operations, such as extraction of candidate time/dates, are all the same, regardless of whether “all participants participate” or “any one participant participates” is selected.

When a plurality of participants are input to the selection input field 520 and “all participants participate” is selected in the radio button 521, the schedule information 311 of all of the participants is referred to, and available time/dates common to all of the participants satisfying the adjustment condition are extracted as the candidate time/dates. In contrast, when a plurality of participants are input to the selection input field 520 and “any one participant participates” is selected in the radio button 521, the schedule information 311 of all of the participants is referred to, and time/dates that are available time/dates of at least one or more of the participants out of the available time/dates of the participants satisfying the adjustment condition are extracted as the candidate time/dates.

FIG. 4 is referred to again. When the adjustment initiator A inputs each item of the adjustment condition and performs operation on the extract candidate time/date button 524 on the condition setting screen 500 displayed in the terminal apparatus 40A (Step S103), the adjustment condition setting unit 212 of the time/date adjustment apparatus 20 creates, in response to the operation, new time/date adjustment information 224 in association with the user information 222 of the adjustment initiator A and causes the storage unit 22 to store the time/date adjustment information 224, and registers the set adjustment condition in the time/date adjustment information 224 (Step S114).

In the present case, the following description will be given based on an assumption that, for example, as illustrated in FIG. 5 to FIG. 7, as the adjustment condition, the topic of the assembly is set to “business discussion with Mr./Ms. xx, ABC company, concerning new product”, the assembly place is set to “adjust”, the change of the designated assembly place by the adjustment partner is set to “permit”, the assembly place is set to “ABC company”, which is different from the workplace, the time required for the assembly is set to “60 minutes”, the time secured before and after the assembly is each set to “30 minutes”, the extraction span of the candidate time/dates is set to 8 business days from “Dec. 16, 2020” to “Dec. 25, 2020”, the time frame available is set to “09:30 to 18:00”, the available time/date addition determination method adopts both of the first and second addition determination methods, the exclusion keyword is set to “*absence allowed”, the exclusion plans are set to “general managers' meeting (in-house)” at 14:00 to 15:00 on December 21st (Monday) and “sales meeting (in-house)” at 10:00 to 12:00 on December 23rd (Wednesday), the site is set to “not designated”, the participant input is set to “the adjustment initiator A and the belonging members B and C belonging to the same corporate member (hereinafter collectively referred to as the participants A, B, and C)”, the assembly participation condition of the input participants is set to “all participants participate”, the email address of the adjustment partner is set to “not input”, and registration of the plan of the assembly is set to “open to public”.

Next, the time/date adjustment unit 213 reads the adjustment condition registered in the time/date adjustment information 224 of the adjustment initiator A from the storage unit 22, refers to the schedule information 311 of the participants managed by the external system 30, and extracts available time/dates of the participants satisfying the adjustment condition at the current time point as the first candidate time/dates (Step S115).

Specifically, in the present case, because both of the first and second addition determination methods are adopted, the existing plans of the participants of which topics include the exclusion keyword and the existing plans of the participants designated as the exclusion plans are excluded from the plans that require participation, and the rest of the existing plans are considered as plans that require participation of the participants. Moreover, because the plurality of participants A, B, and C are designated and “all participants participate” is selected in the radio button 521, the schedule information 311 of each of the participants A, B, and C is referred to, and the available time/dates common to the participants A, B, and C satisfying the adjustment condition (time that is a time frame from 09:30 to 18:00 on a business day between Dec. 16, 2020 to Dec. 25, 2020, in which the plans that require participation are not present, 30 minutes being the time secured after the assembly is excluded from the time in which the assembly can be held before the plans that require participation and 30 minutes being the time secured before the assembly is excluded from the time in which the assembly can be held after the plans that require participation, and 60 minutes being the time required for the assembly can be secured) are extracted as the first candidate time/dates. In contrast, when “any one participant participates” is selected in the radio button 521, the available time/dates of at least one of the participants A, B, and C satisfying the adjustment condition are extracted as the first candidate time/dates. The same holds true for cases in which the second and third candidate time/dates are extracted, which will be described below.

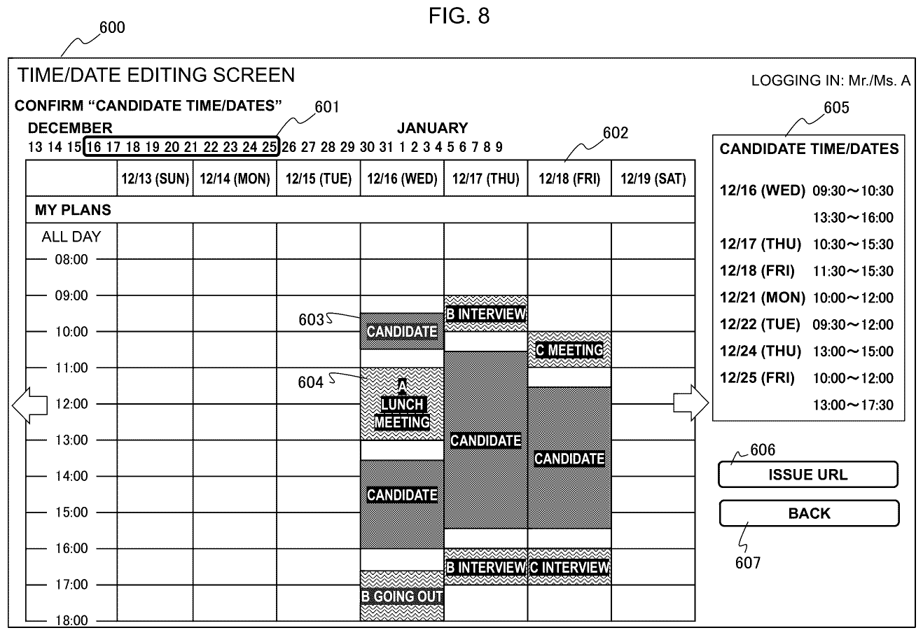

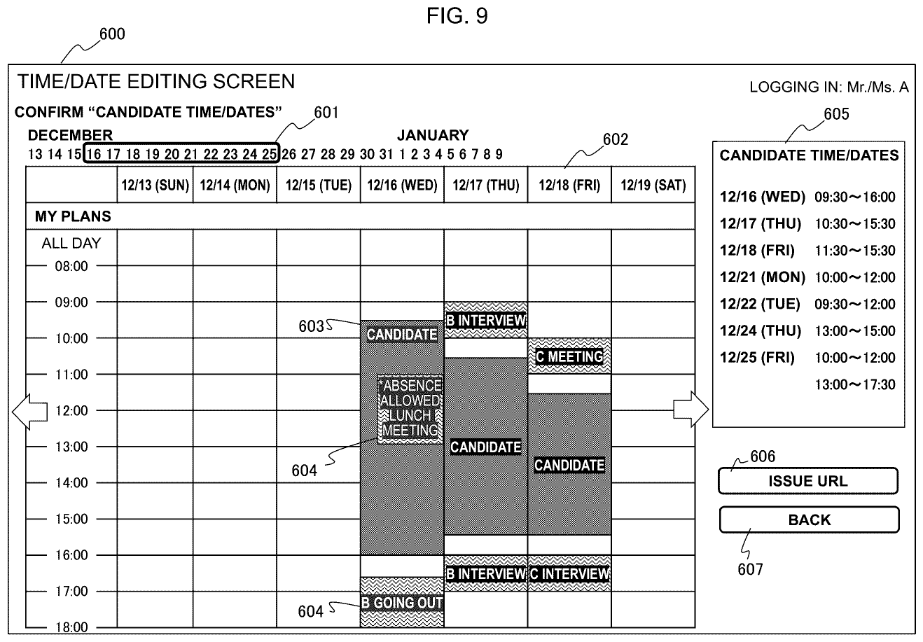

Next, the time/date adjustment unit 213 causes the terminal apparatus 40A to display a time/date editing screen 600 (FIG. 8 and FIG. 9) presenting the first candidate time/dates (Step S116).

FIG. 8 illustrates a display example of the time/date editing screen 600 corresponding to a case in which the exclusion keyword is not included in the topic of the existing plans of the participant. A case in which the exclusion keyword is included in the topic of the existing plans of the participant will be described below with reference to FIG. 9.

On the time/date editing screen 600, a candidate time/date span frame 601, a calendar 602 displayed in a grid pattern with its horizontal axis representing dates and vertical axis representing time, and a candidate time/date list 605 in which the first candidate time/dates are listed per day are displayed. On the time/date editing screen 600, an issue URL button 606 and a back button 607 are provided.

The candidate time/date span frame 601 indicates a span including the first candidate time/dates out of the extraction span of the candidate time/dates input to the selection input field 513 of the condition setting screen 500.

On the calendar 602, based on the schedule information 311 of the participants managed by the external system 30, existing plan frames 604 indicating respective plans of all of the participants and first candidate time/date frames 603 within a display span on the calendar 602 are displayed in different colors or the like so that the existing plan frames 604 and the first candidate time/date frames 603 can be distinguished from each other. With this configuration, the adjustment initiator A can edit the first candidate time/dates while checking existing plans of the participant. Note that, when there are a plurality of participants, names of the participants may be displayed in the existing plan frames 604, or the existing plan frames 604 may be assigned different colors, so as to allow making a distinction as to whose existing plan a plan is out of the plurality of participants.

In the candidate time/date list 605, the first candidate time/dates are listed and displayed per day.

The adjustment initiator A can edit (extend, shorten, partially exclude, entirely exclude) the first candidate time/dates, by using a pop-up screen (not illustrated) to be displayed by selecting the first candidate time/date frame 603 in the calendar 602. For example, on the pop-up screen displayed by selecting a frame of 10:30 to 15:30 on December 17th (Thursday), 10:30 being the starting time and 15:30 being the ending time of the frame may be set to earlier or later time. A part of the frame, for example, 12:00 to 13:00 on the day, can be excluded from the first candidate time/dates, and the entire frame (entire frame of the 10:00 to 15:30) can be excluded from the first candidate time/dates. The editing results of the first candidate time/dates in the calendar 602 are immediately reflected in the candidate time/date list 605. Note that editing of the first candidate time/dates may be performed with an operation, such as drag and drop, on the screen, depending on an operation of an input device (a mouse, a touch panel, or the like) provided for the terminal apparatus 40A. The same holds true for other screen operations in the terminal apparatuses 40A and 40X.

Note that the adjustment initiator A can edit the first candidate time/dates also in the candidate time/date list 605.

The issue URL button 606 is a button for confirming the editing results (second candidate time/dates) of the first candidate time/dates by the adjustment initiator A in the calendar 602 and instructing issuing of the adjustment URL for the adjustment partner to access the time/date adjustment screen. The back button 607 is a button for returning back to the condition setting screen 500.

Next, FIG. 9 illustrates a display example of the time/date editing screen 600 corresponding to a case in which the exclusion keyword is included in the topic of the existing plans of the participant.

Specifically, because the exclusion keyword “*absence allowed” is described in the topic “lunch meeting” of the existing plan of the participant A present at 11:00 to 13:00 on December 16th (Wednesday) illustrated in FIG. 8, the existing plan is excluded from the plans that require participation of the participant A, and thus exactly the same available time/date determination as that in a case in which the existing plan is not present as an existing plan is performed, and 09:30 to 16:00 is the first candidate time/date on the day.

Note that, in FIG. 9, to present from 9:30 to 16:00 on December 16th (Wednesday) being the first candidate time/date, the time frame of 9:30 to 16:00 on the day is displayed in the same color as other first candidate time/date frames 603. Note that, because the existing plan “lunch meeting *absence allowed” is present at 11:00 to 13:00 on the day, the first candidate time/date frame 603 and the existing plan frame 604 with a description of the topic are displayed next to each other at 11:00 to 13:00 on the day in order to clarify that it is the first candidate time/date despite the presence of the existing plan.

Moreover, the adjustment initiator A can designate the existing plan corresponding to the existing plan frame 604 as the exclusion plan on a pop-up screen displayed by selecting the existing plan frame 604 in the calendar 602 of the time/date editing screen 600 (FIG. 8 or FIG. 9). In other words, the adjustment initiator A can also designate the existing plan as the exclusion plan on a screen other than the exclusion plan designation screen 550 (FIG. 7). Note that, also when the exclusion plan is designated on the time/date editing screen 600, similarly to when the exclusion plan is designated on the exclusion plan designation screen 550 (FIG. 7), the adjustment condition setting unit 212 records the plan ID of the existing plan designated as the exclusion plan in the time/date adjustment information 224 corresponding to the adjustment initiator A as the exclusion plan ID. Moreover, the time/date adjustment unit 213 performs available time/date determination again regarding the time frames around the exclusion plan using the adjustment condition including the exclusion plan. Specifically, available time/date determination is performed again on the time frame combining three types of time frames, i.e., the time frame of the exclusion plan, the time frame at the time secured before and after that is excluded from the available time/dates according to the exclusion plan before the exclusion plan is designated, and the time frame of the first candidate time/date frame 603 adjacent to the exclusion plan or the time secured before and after, and displays again the re-determined available time/date as the first candidate time/date frame 603 in the combined time frame.

When the adjustment initiator A extends the first candidate time/date frame 603 in the calendar 602 of the time/date editing screen 600 and the time frames of the first candidate time/date and the existing plan overlap, the existing plan is added to the exclusion plan. When the first candidate time/date frame 603 is extended and the time secured before and after cannot be secured between the first candidate time/date and the existing plan as well, the existing plan is added to the exclusion plan. Note that, when the exclusion plan is added due to extension of the first candidate time/date frame 603, the exclusion plan is added to the adjustment condition, and further, the extended time frame is added to the first candidate time/date frame 603.

For example, when the adjustment initiator A is to extend the first candidate time/date through an operation of setting the starting time of the frame earlier from 10:30 to 10:00 on a pop-up screen displayed by selecting the first candidate time/date frame at 10:30 to 15:30 on December 17th (Thursday) in the calendar 602 of the time/date editing screen 600, the time “30 minutes” to be secured before the assembly cannot be secured, and thus the existing plan “interview of participant B” at 09:00 to 10:00 on the day is added to the exclusion plan, and then the extended time frame at 10:00 to 10:30 is added to the first candidate time/date frame 603. As another example, for example, when the first candidate time/date is extended through an operation of setting the ending time of the first candidate time/date frame on the day later from 15:30 to 17:00, the extended first candidate time/date frame 603 and the existing plan “interview of participant B” at 16:00 to 17:00 on the day overlap as the time frames, and thus the existing plan is added to the exclusion plan, and then the extended time frame at 15:30 to 17:00 is added to the first candidate time/date frame 603. Then, the plan ID of the existing plan added to the exclusion plan is recorded in the time/date adjustment information 224 corresponding to the adjustment initiator A as the exclusion plan ID by the adjustment condition setting unit 212.

Note that, when the existing plan is added to the exclusion plan due to extension of the first candidate time/date frame 603 in the calendar 602, a speech balloon with text “added to exclusion plan” or the like may be displayed in a form of pointing at the existing plan frame 604 that has been added to the exclusion plan immediately after the extension operation, in order that the adjustment initiator A in the middle of operation can recognize the addition of the exclusion plan.

When the exclusion plan is designated using the time/date editing screen 600, the adjustment initiator A can individually designate the exclusion plans more quickly and more simply as compared to when the exclusion plan designation screen 550 is used.

FIG. 4 is referred to again. When the adjustment initiator A edits the first candidate time/dates as necessary and performs operation on the issue URL button 606 on the time/date editing screen 600 displayed in the terminal apparatus 40A (Step S104), next, the time/date adjustment unit 213 of the time/date adjustment apparatus 20 issues the adjustment URL, and registers the adjustment URL and the second candidate time/dates in the time/date adjustment information 224 (created in Step S114) corresponding to the adjustment initiator A (Step S117). In the present case, the following description will be given based on an assumption that the time/date editing screen 600 of FIG. 9 is displayed on the terminal apparatus 40A because the exclusion keyword is included in the topic of the existing plan at 11:00 to 13:00 on December 16th (Wednesday), and the adjustment initiator A performs editing to exclude 15:00 to 16:00 on December 16th (Wednesday) from the first candidate time/dates on the time/date editing screen 600 of FIG. 9.

Next, the time/date adjustment unit 213 causes the terminal apparatus 40A to display the issued adjustment URL and a message for instructing transmission of the adjustment URL to the adjustment partner (Step S118).

Next, in response to the message, the adjustment initiator A copies the adjustment URL displayed in the terminal apparatus 40A, pastes the adjustment URL to an electronic mail or the like, and transmits the adjustment URL to the terminal apparatus 40X of the adjustment partner X (Step S105).

Next, when the adjustment partner X who has received the adjustment URL accesses the adjustment URL using the terminal apparatus 40X (Step S131), the time/date adjustment unit 213 of the time/date adjustment apparatus 20 reads the adjustment condition and the second candidate time/dates registered in the time/date adjustment information 224 of the adjustment initiator A corresponding to the adjustment URL from the storage unit 22, and refers to the schedule information 311 of the participants managed by the external system 30 to extract the third candidate time/dates that are available time/dates of the participants satisfying the adjustment condition at the current time point (the time/dates on which the plans that require participation are not present and the time/dates except the time secured before and after corresponding to the plans that require participation) and are within a range of the second candidate time/dates (Step S119).

In the present case, it is assumed that a plan that requires participation of which topic does not include the exclusion keyword is added to the schedule information 311 of the participant A at 13:00 to 14:00 on December 17th (Thursday) during time from when the adjustment URL is issued to when the adjustment partner X accesses the adjustment URL. In this case, the third candidate time/dates are those obtained by excluding, from the second candidate time/dates, 12:30 to 14:30 on December 17th (Thursday) with “30 minutes” as the time secured before and after the assembly being taken into consideration. In other words, the “time secured before and after” of the adjustment condition is also applied to the plan of the participant that is added after the adjustment URL is issued.

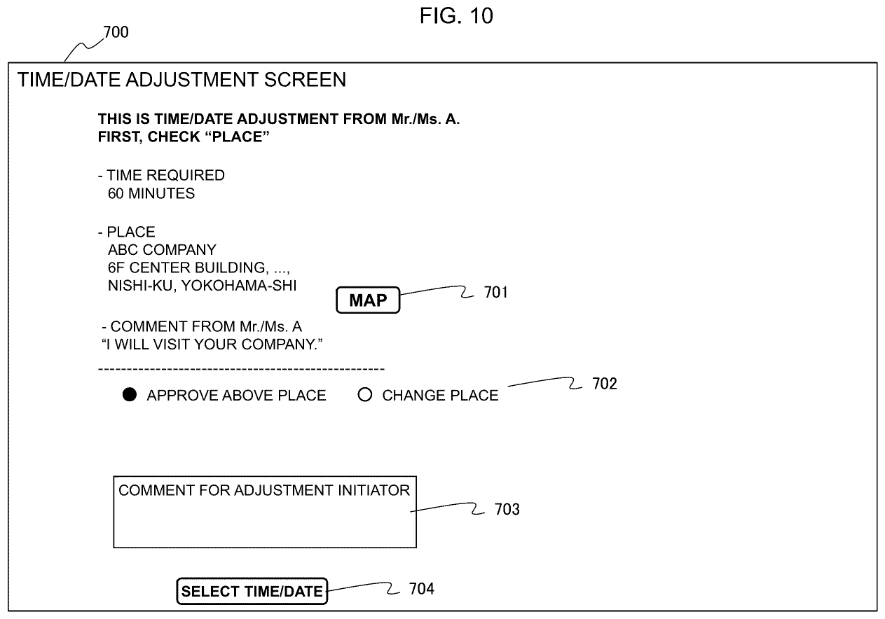

Next, the time/date adjustment unit 213 causes the terminal apparatus 40X to display a time/date adjustment screen 700 (FIG. 10) (Step S120).

FIG. 10 illustrates a display example of the time/date adjustment screen 700. The time/date adjustment screen 700 is a screen for the adjustment partner X to check the place of the assembly. On the time/date adjustment screen 700, the assembly place (a site name, an address, and the like) that the adjustment initiator A has input to the input field 505 of the condition setting screen 500 (FIG. 5) and a MAP button 701 for presenting the assembly place on a map are displayed. Moreover, on the time/date adjustment screen 700, a radio button 702 for selecting whether or not the assembly place designated by the adjustment initiator A is good, an input field 703 for inputting a response comment to the adjustment initiator A, and a select time/date button 704 are provided. Note that it is arranged that the adjustment partner X can select the radio button 702 only when the adjustment initiator A selects “permit change of the place by the adjustment partner” in the radio button 503 on the condition setting screen 500 (FIG. 5). Thus, when the adjustment initiator A selects “not permit change of the place by the adjustment partner” in the radio button 503 on the condition setting screen 500, the adjustment partner X cannot select whether or not the assembly place designated by the adjustment initiator A is good.

When the assembly place displayed on the time/date adjustment screen 700 is not inconvenient, the adjustment partner X may select “approve above place” on the radio button 702 and perform operation on the select time/date button 704. In contrast, when the assembly place displayed on the time/date adjustment screen 700 is inconvenient, the adjustment partner X may select “change place” in the radio button 702. In response to “change place” being selected, an input field (not illustrated) for the adjustment partner X to input a changed destination (a place name, an address, a building name, a floor number, and the like) of the assembly place is additionally displayed on the time/date adjustment screen 700, and the adjustment partner X may input a changed destination of the assembly place to the input field and perform operation on the select time/date button 704.

Note that, when the adjustment initiator A selects “not adjust assembly place” in the radio button 502 on the condition setting screen 500, the display field and the input field for the assembly place are not displayed.

When the adjustment initiator A selects “web meeting” in the radio button 504 on the condition setting screen 500, a message indicating that a web meeting is to be held and a name of a videotelephony application as a method (means) of the assembly to be used for the web meeting are displayed on the time/date adjustment screen 700 instead of the assembly place, and description indications of the radio button 702 are changed to “approve above” and “change” (not illustrated), for example. When the videotelephony application displayed on the time/date adjustment screen 700 is not inconvenient, the adjustment partner X may select “approve above” in the radio button 702 and perform operation on the select time/date button 704. In contrast, when the videotelephony application displayed on the time/date adjustment screen 700 is inconvenient, the adjustment partner X may select “change” in the radio button 702. When the adjustment partner X selects “change”, the adjustment partner X may input, for example, “I do not use a first videotelephony application. I request to use a second videotelephony application” or the like to the comment input field, and perform operation on the select time/date button 704.

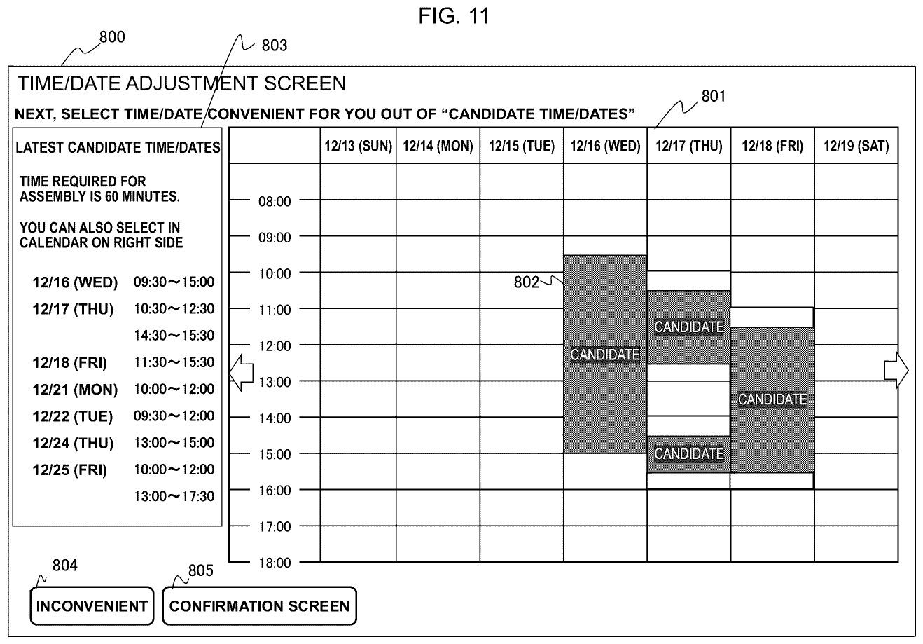

When the adjustment partner X performs operation on the select time/date button 704 on the time/date adjustment screen 700, a time/date adjustment screen 800 (FIG. 11) is displayed in the terminal apparatus 40X.

FIG. 11 illustrates a display example of the time/date adjustment screen 800 presenting the third candidate time/dates. On the time/date adjustment screen 800, a calendar 801 displayed in a grid pattern with its horizontal axis representing dates and vertical axis representing time and a candidate time/date list 803 in which the third candidate time/dates are listed per day are displayed. On the time/date adjustment screen 800, an inconvenient button 804 and a confirmation screen button 805 are provided.

In the calendar 801, third candidate time/date frames 802 are displayed in different colors or the like so that the third candidate time/date frames 802 can be distinguished from other frames. Note that, in the calendar 801, existing plans of the participant are not displayed, unlike the calendar 602 of the time/date editing screen 600 (FIG. 8 or FIG. 9). Thus, for the adjustment partner X, privacy of the participant can be protected.

In the candidate time/date list 803, the time required for the assembly and the third candidate time/dates listed per day are displayed.

The adjustment partner X can select the assembly time/date by selecting one of the third candidate time/date frames 802 in the calendar 801. Note that, when a frame longer than “60 minutes” as the time required for the assembly is selected, a pop-up screen (not illustrated) is displayed. The adjustment partner X can determine the assembly time/date by selecting “60 minutes” as the time required within time of the selected frame on the pop-up screen.

The inconvenient button 804 is a button on which operation is performed when the third candidate time/dates presented on the time/date adjustment screen 800 are inconvenient. When the adjustment partner X performs operation on the inconvenient button 804, the adjustment initiator A is notified that suggested candidate time/dates are inconvenient. In this case, the adjustment initiator A changes the adjustment condition, and executes the time/date adjustment processing again.

The confirmation screen button 805 is a button for checking with the determined assembly time/date. When the adjustment partner X performs operation on the confirmation screen button 805, the time/date confirmation screen 900 (FIG. 12) for the adjustment partner X themselves to confirm with the assembly time/date selected and determined out of the third candidate time/dates is displayed in the terminal apparatus 40X.

In the present case, the following description will be given based on an assumption that the adjustment partner X determines 11:00 to 12:00 on December 17th (Thursday) as the assembly time/date on the time/date adjustment screen 800.

FIG. 12 illustrates a display example of the time/date confirmation screen 900. On the time/date confirmation screen 900, a calendar 901 displayed in a grid pattern with its horizontal axis representing dates and vertical axis representing time and an assembly detail 903 are displayed.

In the calendar 901, an assembly time/date frame 902 selected and determined on the time/date adjustment screen 800 by the adjustment partner X themselves is displayed in different colors or the like so that the assembly time/date frame 902 can be distinguished from other frames. In the assembly detail 903, the time/date and the place of the assembly (in the present case, 11:00 to 12:00 on December 17th (Thursday) at ABC company, . . . ) is displayed. Note that, when the adjustment partner X selects “change place” in the radio button 702 and enters the changed destination of the site in the input field 703 on the time/date adjustment screen 700 (FIG. 10), the place name, the address, the building name, the floor number, and the like that the adjustment partner X has input as the changed destination of the assembly place are displayed in the assembly detail 903. When the adjustment partner X has input a comment on the time/date adjustment screen 800, the comment is displayed in the assembly detail 903.

The time/date confirmation screen 900 is provided with an input field 904 for the adjustment partner X to input an email address of the adjustment partner X, a check box 905 for setting a timing of transmitting an email for notifying the adjustment partner X of holding of the assembly, a back button 906 for returning back to the time/date adjustment screen 800, and a confirmation button 907 for confirming the details displayed on the time/date confirmation screen 900.

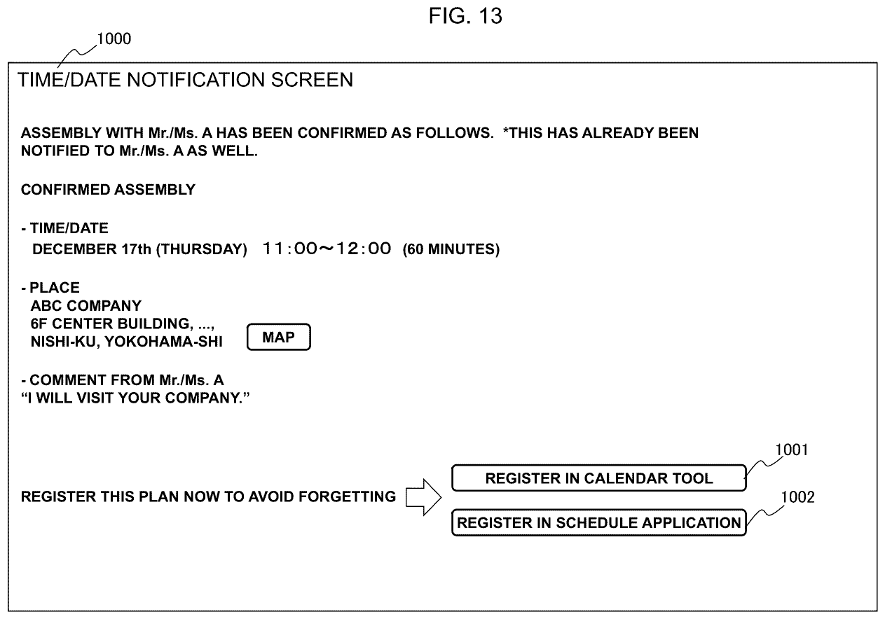

FIG. 4 is referred to again. When the adjustment partner X inputs the email address of the adjustment partner X to the input field 904 and performs operation on the confirmation button 907 on the time/date confirmation screen 900 (FIG. 12) displayed in the terminal apparatus 40X (Step S132), the time/date adjustment unit 213 refers to the schedule information 311 of the participant managed by the external system 30, and performs final check that the assembly time/date confirmed on the time/date confirmation screen 900 is an available time/date of the participant satisfying the adjustment condition at the current time point and is within a range of the second candidate time/dates (Step S121). Here, when the confirmed assembly time/date is no longer an available time/date because the participant has made a plan or no longer satisfies the adjustment condition, for example, a message such as “The designated time has been occupied. Select again” may be displayed on the terminal apparatus 40X, and the processing may be brought back to Step S119 and may resume from the operation of the adjustment partner X on the time/date adjustment screen 800. In contrast, when final check is successfully performed that the confirmed assembly time/date is an available time/date of the participant satisfying the adjustment condition and is within a range of the second candidate time/dates, a time/date notification screen 1000 (FIG. 13) presenting the time/date of the assembly and the like confirmed by the adjustment partner X themselves is displayed in the terminal apparatus 40X (Step S122).

FIG. 13 illustrates a display example of the time/date notification screen 1000. On the time/date notification screen 1000, the confirmed time/date of the assembly, the place, the comment from the adjustment initiator A, and the like are displayed. On the time/date notification screen 1000, a register button 1001 for the calendar tool and a register button 1002 for a schedule application are provided. When the adjustment partner X uses the calendar tool 31 and performs operation on the register button 1001, the adjustment partner X can register the plan of the confirmed assembly in the calendar tool 31 as a plan of the adjustment partner X themselves. When the adjustment partner X performs operation on the register button 1002, the adjustment partner X can register the plan of the confirmed assembly in an application program (for example, Outlook (trademark) or the like) for schedule management used by the adjustment partner X.

FIG. 4 is referred to again. When final check is successfully performed that the confirmed assembly time/date is an available time/date of the participant satisfying the adjustment condition and is within a range of the second candidate time/dates in the final check of Step S121, the time/date adjustment unit 213 registers the plan of the assembly with the adjustment partner X in the schedule information 311 of the participant managed by the external system 30. The time/date adjustment unit 213 registers the email address of the adjustment partner X, the timing of transmitting the notification email, the date and time of the assembly, the place thereof, and the like in the time/date adjustment information 224 (created in Step S114) corresponding to the adjustment initiator A, stored in the storage unit 22 (Step S123). Note that, when the assembly is a web meeting, instead of the place, the time/date adjustment unit 213 issues a web meeting URL, and registers the web meeting URL in the time/date adjustment information 224. Note that whether or not the time/date adjustment unit 213 issues the Web meeting URL is dependent upon settings of the adjustment initiator A.

In the present case, the participants A, B, and C are designated in the selection input field 520 of the condition setting screen 500 (FIG. 6) and “all participants participate” is selected in the radio button 521, and thus the time/date adjustment unit 213 registers the plan of the assembly with the adjustment partner X in the schedule information 311 of each of the participants A, B, and C managed by the external system 30. In contrast, when “any one participant participates” is selected in the radio button 521, the plan of the assembly with the adjustment partner X may be registered in the schedule information 311 of all of the persons having an available time/date on the confirmed assembly time/date out of the participants A, B, and C, or one person may be selected out of persons having an available time/date on the confirmed assembly time/date and the plan of the assembly with the adjustment partner X may be registered in the schedule information 311 of the one selected person. Note that, regarding selection of the participant, the time/date adjustment unit 213 may perform selection in accordance with a predetermined rule, or the adjustment initiator A may perform selection.

Next, the time/date adjustment unit 213 transmits the notification email for notifying the adjustment partner X of holding of the assembly to the email address designated by the adjustment partner X, in accordance with the timing of transmission selected by the adjustment partner X themselves (Step S124).

Note that, in the present embodiment, an arrow from the time/date adjustment apparatus 20 to the terminal apparatus 40X is illustrated as Step S124, on the assumption that the adjustment partner X receives the electronic mail using the terminal apparatus 40X; however, the adjustment partner X may receive the notification email from the time/date adjustment apparatus 20, using an electronic device other than the terminal apparatus 40X. Through the above processing, the time/date adjustment processing performed by the time/date adjustment system 10 ends.

Note that, in the foregoing description, the adjustment initiator A does not designate a site of the assembly; however, when the adjustment initiator A designates a site in the selection input field 519 of the condition setting screen 500 (FIG. 6), the first candidate time/dates and the third candidate time/dates may be extracted such that available time/dates of the site are satisfied as well. Note that, regarding the available time/dates of the site, determination as to whether or not the exclusion keyword is included in the topic of the plan is not performed, and time/dates without existing plans are extracted.

Specifically, for example, when only “first meeting room” is designated as the site, in Step S115, the time/date adjustment unit 213 may read the adjustment condition registered in the time/date adjustment information 224 of the adjustment initiator A from the storage unit 22, and refer to the schedule information 311 of the participants and the first meeting room managed by the external system 30 to extract the first candidate time/dates that are available time/dates common to the participants and the first meeting room at the current time point and satisfy the adjustment condition. In Step S119, the time/date adjustment unit 213 may read the adjustment condition and the second candidate time/dates registered in the time/date adjustment information 224 of the adjustment initiator A corresponding to the accessed adjustment URL from the storage unit 22, and refer to the schedule information 311 of the participants and the first meeting room managed by the external system 30 to extract the third candidate time/dates that are available time/dates common to the participants and the meeting room satisfying the adjustment condition at the current time point and are within a range of the second candidate time/dates. Moreover, in Step S123, the time/date adjustment unit 213 may register the plan of the assembly with the adjustment partner X in the schedule information 311 of each of the participants and the first meeting room managed by the external system 30.

For example, when two rooms of “first meeting room and second meeting room” are designated as the site, in Step S115, the time/date adjustment unit 213 may read the adjustment condition registered in the time/date adjustment information 224 of the adjustment initiator A from the storage unit 22, refer to the schedule information 311 of the participants, the first meeting room, and the second meeting room managed by the external system 30, and extract the first candidate time/dates that are available time/dates of the participants, available time/dates of at least one room of the first meeting room and the second meeting room, and satisfy the adjustment condition, at the current time point.

In Step S119, the time/date adjustment unit 213 may read the adjustment condition and the second candidate time/dates registered in the time/date adjustment information 224 of the adjustment initiator A corresponding to the accessed adjustment URL from the storage unit 22, refer to the schedule information 311 of the participants, the first meeting room, and the second meeting room managed by the external system 30, and extract the third candidate time/dates that are available time/date of the participant satisfying the adjustment condition, available time/dates of at least one room of the first meeting room and the second meeting room satisfying the adjustment condition, and are within a range of the second candidate time/dates, at the current time point. Moreover, when two rooms of the first meeting room and the second meeting room are available on the confirmed assembly time/date, one room of the first meeting room and the second meeting room is selected, and the plan of the assembly with the adjustment partner X is registered in the schedule information 311 of the selected site. Note that, regarding selection of the site, the time/date adjustment unit 213 may perform selection in accordance with a predetermined rule, or the adjustment initiator A may perform selection. Then, in Step S123, the time/date adjustment unit 213 may register the plan of the assembly with the adjustment partner X in the schedule information 311 of each of the participants and the selected site managed by the external system 30.

According to the time/date adjustment processing described above, a time/date of an assembly in which one or more participants and the adjustment partner X participate can be easily and efficiently set without causing a double booking with an existing plan having a high priority while permitting a double booking with an existing plan having a low priority for the participants.

According to the time/date adjustment processing, the confirmed time/date of the assembly and the like can be registered in the calendar tool 31 used by the participant. Therefore, time and efforts for conventionally required manual registration of the schedule in the calendar tool 31 can be eliminated.

Moreover, according to the time/date adjustment processing, the place of the assembly or the method of the assembly designated by the adjustment initiator A can be changed by the adjustment partner X.

In addition, from the standpoint of the adjustment initiator A, operations from extraction of the candidate time/dates to transmitting the candidate time/dates to the adjustment partner X can be performed in a short period of time (for example, approximately 30 seconds), and after transmitting the candidate time/dates to the adjustment partner X, the adjustment initiator A only has to wait and can have important operations regarding time/date adjustment automatically completed, which includes not only determination of the time/date but also adjustment of the place of the assembly or the method of the assembly and registration of the plan. This can significantly reduce time and efforts for the operations regarding time/date adjustment.

<Case in which “Use Template” Is Selected as Method of Time/Date Adjustment>

Next, a case in which the adjustment initiator A selects “use template” as the method of time/date adjustment will be described. In a case of “use template”, the adjustment condition template created by the adjustment initiator A themselves in advance is selected, and the adjustment URL designated by the adjustment initiator A themselves in advance is copied, and the adjustment URL can be thereby more promptly transmitted to the adjustment partner X, in comparison to customized adjustment. Note that the adjustment condition template created by the adjustment initiator A in advance may be designated and edited by another user, and the adjustment URL may be copied and used for time/date adjustment.

A user such as the adjustment initiator A can create the adjustment condition templates in advance, depending on a purpose of the assembly, such as “for a first interview for recruitment of a new graduate”, “for a second interview for recruitment of a new graduate”, “for a final interview for recruitment of a new graduate”, and “for sales for an inquiry”, for example.

Note that, in a case of “customized adjustment”, the adjustment condition is set every time adjustment of a time/date of an assembly is performed; however, the adjustment condition template can be repeatedly used for adjustment of time/dates of different assemblies again and again.

### <Adjustment Condition Template Creation Processing>

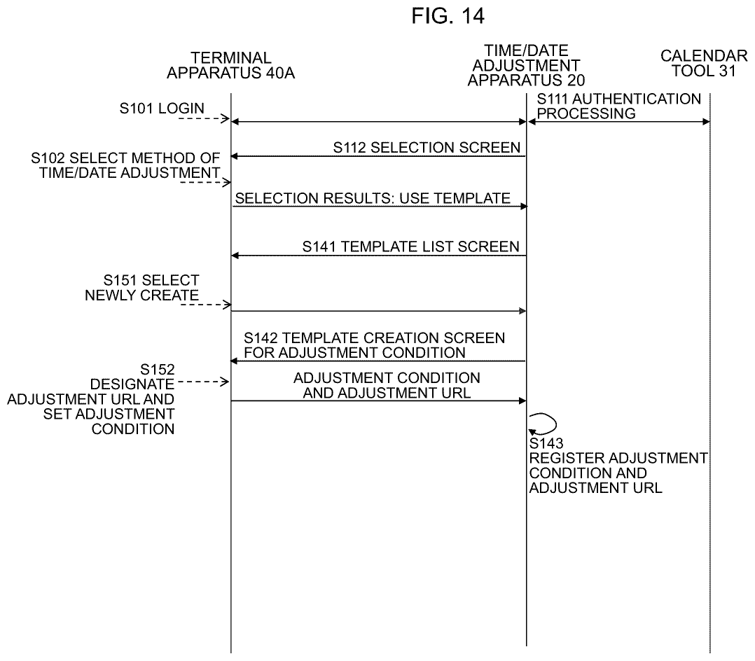

FIG. 14 is a sequence diagram for illustrating an example of adjustment condition template creation processing.

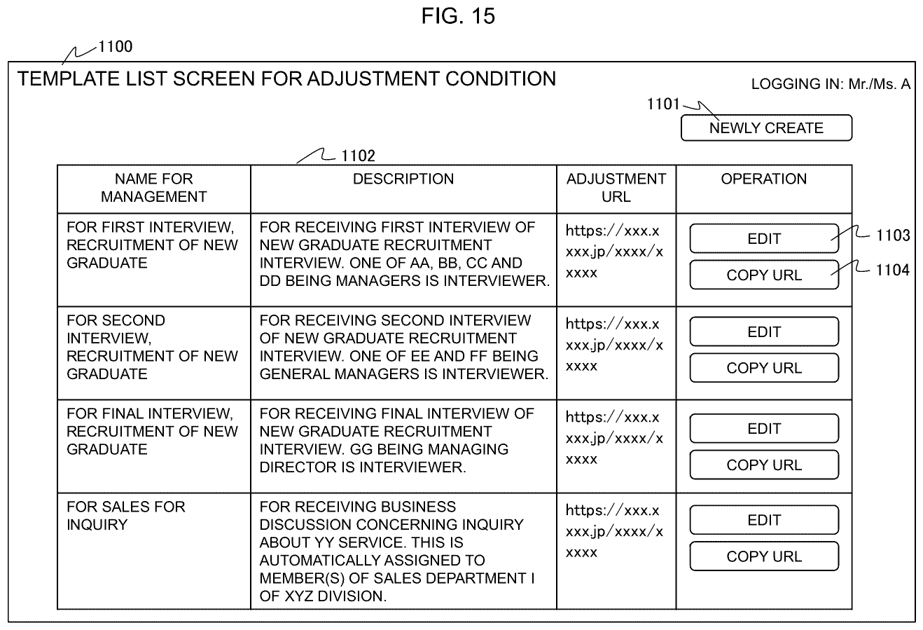

The adjustment condition template creation processing includes Steps S101, S111, S112, and S102 similar to those of the time/date adjustment processing illustrated in FIG. 4. Then, when the adjustment initiator A selects “use template” as the method of time/date adjustment in Step S102, next, the adjustment condition setting unit 212 of the time/date adjustment apparatus 20 refers to the adjustment condition template information 223 associated with the user information 222 corresponding to the adjustment initiator A, and causes the terminal apparatus 40A to display a template list screen 1100 (FIG. 15) presenting a list of adjustment condition templates available to the adjustment initiator A (Step S141).

FIG. 15 illustrates a display example of the template list screen 1100 displayed in the terminal apparatus 40A.

The template list screen 1100 is provided with a newly create button 1101 and a template list 1102 presenting a list of adjustment condition templates available to the adjustment initiator A. In the template list 1102, a name for management, a description, an adjustment URL, an edit button 1103, and a URL copy button 1104 are displayed for each template.

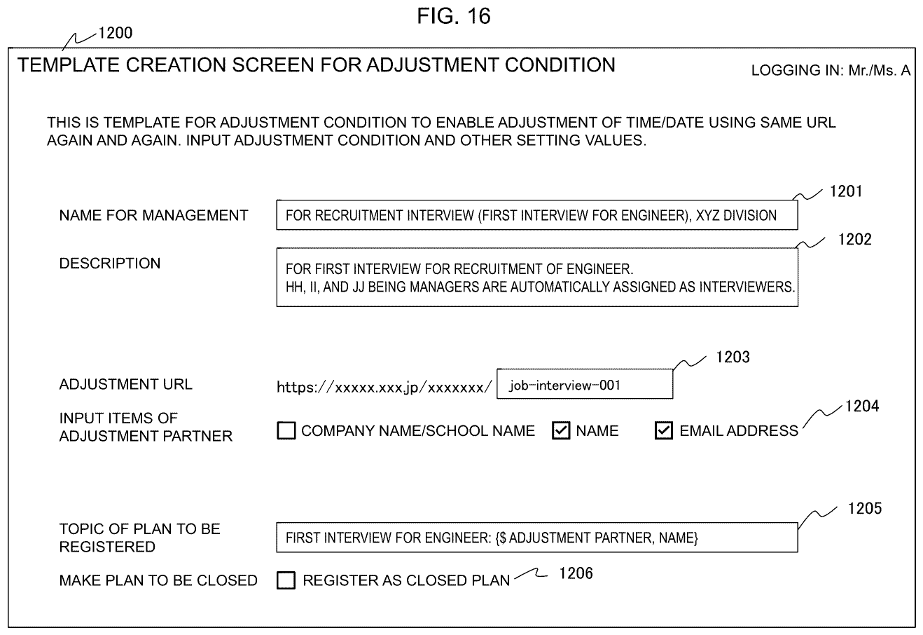

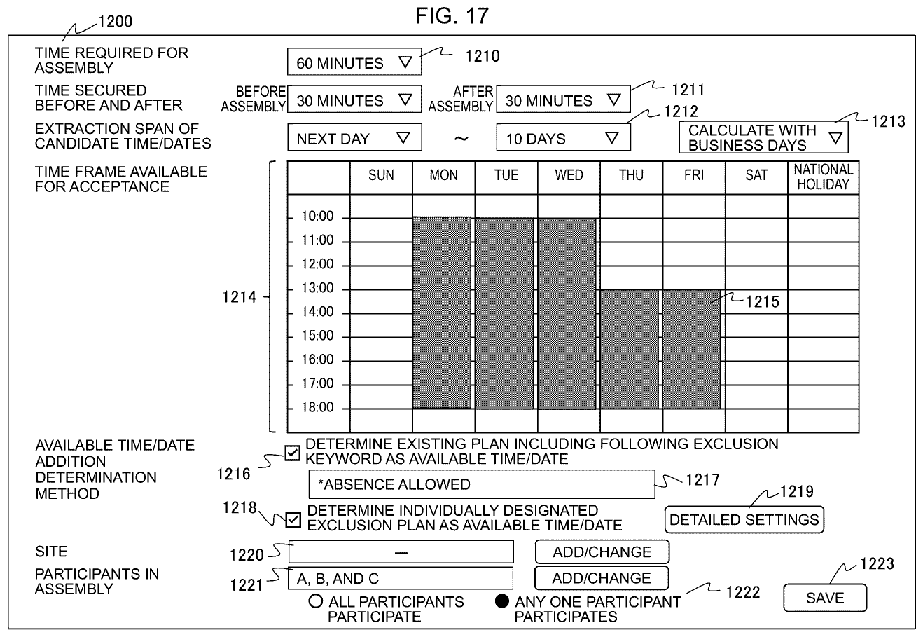

The newly create button 1101 is a button for instructing proceeding to a template creation screen 1200 (FIG. 16 and FIG. 17), on which a new adjustment condition template can be created. The edit button 1103 is a button for instructing proceeding to a screen (not illustrated; similar to the template creation screen 1200), on which a created adjustment condition template can be edited. The URL copy button 1104 is a button for instructing copying of the adjustment URL.

FIG. 14 is referred to again. When the adjustment initiator A performs operation on the newly create button 1101 on the template list screen 1100 displayed in the terminal apparatus 40A (Step S151), next, the adjustment condition setting unit 212 causes the terminal apparatus 40A to display the template creation screen 1200 (Step S142).

FIG. 16 and FIG. 17 illustrate display examples of the template creation screen 1200. FIG. 16 illustrates an upper part of the template creation screen 1200, and FIG. 17 illustrates a lower part of the template creation screen 1200, which is displayed by scrolling down the upper part illustrated in FIG. 16.

As illustrated in FIG. 16, the template creation screen 1200 is provided with an input field 1201 for inputting a name for management of the template, an input field 1202 for inputting a description of the template, an input field 1203 for the user to designate an adjustment URL, a check box 1204 for designating a company name/school name, a name, and an email address as input items of the adjustment partner X, and an input field 1205 for inputting a topic of the plan to be used in registration in the calendar tool 31 after the time/date is confirmed.

Moreover, as illustrated in FIG. 17, the template creation screen 1200 is provided with a selection input field 1210 for inputting time required for the assembly, a selection input field 1211 for inputting time secured before and after the assembly, a selection input field 1212 for inputting the extraction span of the candidate time/dates, a selection input field 1213 for selecting and inputting a method of calculating the number of days to be extracted for the extraction span (for example, calculation with business days, calculation with calendar days, or the like), an input field 1214 for designating a time frame available for the assembly for each day of the week and national holiday (a frame 1215 denotes a time frame designated as the time frame available for the assembly), a check box 1216 for instructing adopting the first addition determination method (the method of designating the exclusion keyword) as the available time/date addition determination method, an input field 1217 for inputting the exclusion keyword when the check box 1216 is checked (when the first addition determination method is adopted), a check box 1218 for instructing adopting the second addition determination method (the method of individually designating the exclusion plan) as the available time/date addition determination method, a detail setting button 1219 for transitioning to the exclusion plan designation screen 550 (FIG. 7) for designating the exclusion plan when the check box 1218 is checked (when the second addition determination method is adopted), a selection input field 1220 for selecting and designating one or more rooms as the site to be used for the assembly out of a site list based on the site information of the member information 221, a selection input field 1221 for selecting and designating one or more participants out of the belonging member list based on the belonging member information of the member information 221, a radio button 1222 for selecting the assembly participation condition of the participant(s) designated in the selection input field 1221, and a save button 1223 for instructing saving of input contents.

As can be seen from the template creation screen 1200 being provided with the check boxes 1216 and 1218, the input field 1217, and the detail setting button 1219 similar to the check boxes 515 and 517, the input field 516, and the detail setting button 518 of the condition setting screen 500 (FIG. 6), also when the adjustment condition template is used, available time/date addition determination of the participants can be performed similarly to the case of the customized adjustment described above.

Note that, in the selection input field 1212 for inputting the extraction span of the candidate time/dates on the template creation screen 1200, start timing (in the case of the figure, next day) of the extraction span from the date and time on which the adjustment partner performs access based on the adjustment URL and a span (in the case of the figure, 10 days) from the start timing can be designated in order to provide versatility, unlike the selection input field 513 of a similar purpose provided on the condition setting screen 500 (FIG. 6) corresponding to customized adjustment where a specific date, month, and year are selected. Thus, the adjustment condition template can be repeatedly used for adjustment of time/dates of different assemblies again and again.

FIG. 14 is referred to again. When the adjustment initiator A finishes inputting each item of the adjustment condition and then performs operation on the save button 1223 on the template creation screen 1200 displayed in the terminal apparatus 40A (Step S152), next, the adjustment condition setting unit 212 creates the adjustment condition template information 223, registers the adjustment condition and the adjustment URL set on the template creation screen 1200, and records the adjustment condition template information 223 in the storage unit 22 in association with the user information 222 of the adjustment initiator A (Step S143). Through the above processing, the processing of creating the adjustment condition template ends.

### <Time/Date Adjustment Processing Using Adjustment Condition Template>

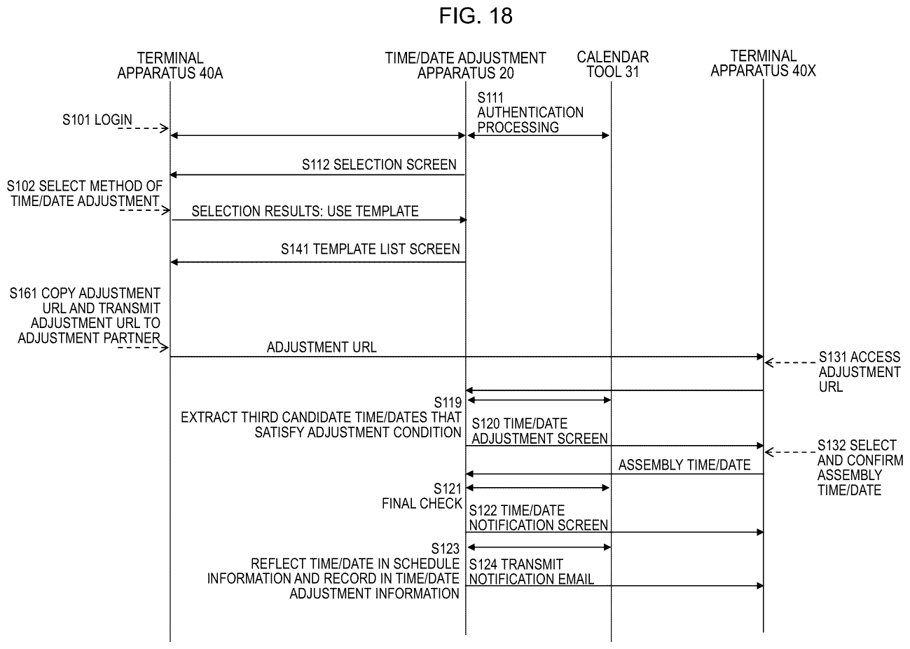

Next, FIG. 18 is a sequence diagram for illustrating another example of the time/date adjustment processing using the adjustment condition template.

Such another example includes Steps S101, S111, S112, S102, and S141 similar to those of the adjustment condition template creation processing illustrated in FIG. 14. Then, in Step S141, on the template list screen 1100 (FIG. 15) displayed in the terminal apparatus 40A, the adjustment initiator A selects one of the templates, performs operation on the URL copy button 1104 to copy the adjustment URL, pastes the adjustment URL to an electronic mail or the like, and transmits the adjustment URL to the terminal apparatus 40X of the adjustment partner X (Step S161).

The following processing is similar to Step S131 and subsequent steps of the time/date adjustment processing illustrated in FIG. 4, and thus description thereof will be omitted.

Note that, in the present case, in Step S119, the first candidate time/dates and the second candidate time/dates obtained by editing the first candidate time/dates by the adjustment initiator A are not present, and thus the available time/dates of the participants satisfying the adjustment condition at the current time point may be extracted as the third candidate time/dates. Here, regarding the available time/dates of the participant, in the adjustment condition of the selected template, when the check boxes 1216 and 1218 are not checked, in other words, when neither of the first and second addition determination methods is adopted, the time/date adjustment unit 213 considers all of the existing plans of the participant as plans that require participation, and determines the time/dates on which the plans that require participation of the participant are not present except the time secured before and after corresponding to the plans that require participation of the participant as the available time/dates of the participant.

When the check box 1216 is checked and the check box 1218 is not checked, in other words, when the first addition determination method is adopted and the second addition determination method is not adopted, the time/date adjustment unit 213 excludes the existing plans of the participant of which topics include the exclusion keyword from the plans that require participation, considers only the rest of the existing plans as plans that require participation of the participant, and determines the time/dates on which the plans that require participation of the participant are not present except the time secured before and after corresponding to the plans that require participation of the participant as the available time/dates of the participant.

When the check box 1216 is not checked and the check box 1218 is checked, in other words, when the first addition determination method is not adopted and the second addition determination method is adopted, the time/date adjustment unit 213 excludes the existing plans of the participant designated as the exclusion plans from the plans that require participation, considers the rest of the existing plans as plans that require participation of the participant, and determines the time/dates on which the plans that require participation of the participant are not present except the time secured before and after corresponding to the plans that require participation of the participant as the available time/dates of the participant.

When both of the check boxes 1216 and 1218 are checked, in other words, when both of the first and second addition determination methods are adopted, the time/date adjustment unit 213 excludes the existing plans of the participant of which topics include the exclusion keyword and the existing plans of the participant designated as the exclusion plans from the plans that require participation, considers the rest of the existing plans as plans that require participation of the participant, and determines the time/dates on which the plans that require participation of the participant are not present except the time secured before and after corresponding to the plans that require participation of the participant as the available time/dates of the participant.

In the present case, the time/date confirmation screen 900 (FIG. 12) displayed in Step S132 is provided with input fields corresponding to the items selected in the check box 1204 as the input items of the adjustment partner on the template creation screen 1200 (FIG. 16) (an input field for inputting a company name/school name, an input field for inputting a name), instead of or in addition to the input field 904 for inputting an email address. Moreover, in the present case, in Step S123, the topic of the plan to be registered in the schedule information 311 of the participants can be generated by combining fixed text and the company name/school name, the name, and the like input by the adjustment partner X in the input fields corresponding to the items selected in the check box 1204.

According to another example of the time/date adjustment processing described above (a case of selecting use of the adjustment condition template), in addition to effects similar to those of the time/date adjustment processing of FIG. 4 (a case of selecting customized adjustment), the adjustment initiator A merely selects the adjustment condition template and transmits the adjustment URL as their operation, and therefore time and efforts taken by the adjustment initiator A can be significantly reduced, in comparison to the case of customized adjustment.

In addition, in time/date adjustment in business, a pattern of the participants, the site, the time frame, and the like is, to a certain degree, determined for each situation (type of assembly), such as an interview, a sales visit, having a visitor, and a web meeting. Thus, once the adjustment condition template for each situation is created and registered in advance, by merely selecting the template, the adjustment URL can be instantly transmitted to the adjustment partner X.

Because the adjustment condition template can be repeatedly used and the adjustment URL corresponding to each adjustment condition template is fixed, for example, by attaching a link of the adjustment URL subsequently to an inquiry form of a website of a company, time/date adjustment can be performed without the time and efforts taken to transmit the adjustment URL to the adjustment partner X.

By attaching the adjustment URL to an email for simultaneous distribution or the like, the adjustment URL can be simultaneously transmitted to a plurality of adjustment partners X.

Typically, for example, the time/date adjustment apparatus of the present embodiment can prepare various operation screens as web pages, and can display such operation screens in a web browser of the terminal apparatus. However, this aspect is not restrictive. For example, a dedicated application including various operation screens may be installed in the terminal apparatus. In this case, by transmitting a part of contents (data such as candidate time/dates) to be displayed on various operation screens to the terminal apparatus, the time/date adjustment apparatus can cause the dedicated application of the terminal apparatus to display various operation screens. In other words, the time/date adjustment apparatus of the present invention may also encompass various aspects in which screens can be displayed in the terminal apparatus.

The present invention is not limited to the embodiments and modifications described above, and further various modifications can be made. For example, the embodiments and the modifications described above are described in detail in order to give simple description of the present invention, and are not necessarily limited to those including all of the configurations described above. A part of one modification may be replaced with another modification, or modifications may be combined together.

A part or all of each configuration, function, processing unit, processing means, and the like described above may be, for example, implemented with hardware by designing those with an integrated circuit, for example. Each configuration, function, and the like described above may be implemented with software by a processor interpreting and executing a program for implementing their respective functions. Information such as a program, a table, and a file for implementing respective functions may be stored in a recording apparatus such as a memory, a hard disk, and an SSD, or a recording medium such as an IC card, an SD card, and a DVD. Illustrated control lines and information lines are those considered to be necessary for the sake of description, and not necessarily all of control lines and information lines for a product are illustrated. It may be considered that most of the configurations are connected to each other in actuality.

### REFERENCE SIGNS LIST

10 . . . Time/date adjustment system
11 . . . Network
20 . . . Time/date adjustment apparatus
21 . . . Processing unit
211 . . . Authentication unit
212 . . . Adjustment condition setting unit
213 . . . Time/date adjustment unit
22 . . . Storage unit
221 . . . Member information
222 . . . User information
223 . . . Adjustment condition template information
224 . . . Time/date adjustment information
23 . . . Communication unit
30 . . . External system
31 . . . Calendar tool
311 . . . Schedule information
40A, 40M, 40X . . . Terminal apparatus
500 . . . Condition setting screen
550 . . . Exclusion plan designation screen
600 . . . Time/date editing screen
700 . . . Time/date adjustment screen
800 . . . Time/date adjustment screen
900 . . . Time/date confirmation screen
1000 . . . Time/date notification screen
1100 . . . Template list screen
1200 . . . Template creation screen

1. A time/date adjustment apparatus comprising:
an adjustment condition setting unit configured to set an adjustment condition related to an assembly; and
a time/date adjustment unit configured to adjust an assembly time/date based on the adjustment condition, wherein
the adjustment condition setting unit sets the adjustment condition including a participant and designation of an exclusion keyword in response to an input of an adjustment initiator,
the time/date adjustment unit is configured to exclude an existing plan of which information related to the existing plan includes the exclusion keyword out of the existing plans of the participant in schedule information managed by an external system from plans that require participation, consider a rest of the existing plans as the plans that require participation, and determine time/dates on which the plans that require participation are not present as available time/dates of the participant,
when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates,
the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and
the time/date adjustment unit registers the determined assembly time/date in the schedule information of the participant managed by the external system.

2. A time/date adjustment apparatus comprising:
an adjustment condition setting unit configured to set an adjustment condition related to an assembly; and
a time/date adjustment unit configured to adjust an assembly time/date based on the adjustment condition, wherein
the adjustment condition setting unit sets the adjustment condition including a participant and designation of an exclusion plan in response to an input of an adjustment initiator,
the time/date adjustment unit is configured to exclude an existing plan designated as the exclusion plan by the adjustment initiator out of the existing plans of the participant in schedule information managed by an external system from plans that require participation, consider a rest of the existing plans as the plans that require participation, and determine time/dates on which the plans that require participation are not present as available time/dates of the participant,
when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates,
the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and
the time/date adjustment unit registers the determined assembly time/date in the schedule information of the participant managed by the external system.

3. The time/date adjustment apparatus according to claim 1 or 2, wherein
the adjustment condition setting unit sets the adjustment condition including designation of time secured before and after, in response to the input of the adjustment initiator, and
the time/date adjustment unit determines time/dates on which the plans that require participation are not present except the time secured before and after corresponding to the plans that require participation as the available time/dates of the participant.

4. The time/date adjustment apparatus according to claim 2, wherein
the adjustment condition setting unit causes the existing plan designated by the adjustment initiator out of a displayed list of the existing plans of the participant to be the exclusion plan.

5. The time/date adjustment apparatus according to claim 1 or 2, wherein
the time/date adjustment unit determines second candidate time/dates, in response to the input of the adjustment initiator for a time/date editing screen,
the time/date adjustment unit issues the access information,
when the adjustment partner performs access based on the access information, the time/date adjustment unit refers to the schedule information of the participant to extract third candidate time/dates that are the available time/dates of the participant satisfying the adjustment condition and are within a range of the second candidate time/dates,
the time/date adjustment unit displays the time/date adjustment screen presenting the extracted third candidate time/dates on the second terminal apparatus, and determines the assembly time/date out of the third candidate time/dates in response to the selection operation of the adjustment partner for the time/date adjustment screen, and
the time/date adjustment unit registers the determined assembly time/date in the schedule information of the participant managed by the external system.

6. The time/date adjustment apparatus according to claim 5, wherein
the time/date adjustment unit refers to the schedule information of the participant managed by the external system to extract the available time/dates of the participant satisfying the adjustment condition as a first candidate time/dates, and
the time/date adjustment unit displays the time/date editing screen for editing the extracted first candidate time/dates on a first terminal apparatus used by the adjustment initiator.

7. The time/date adjustment apparatus according to claim 5, wherein
the adjustment condition setting unit causes the existing plan of the participant designated by the adjustment initiator on the time/date editing screen to be the exclusion plan.

8. The time/date adjustment apparatus according to claim 1 or 2, wherein
the adjustment condition setting unit displays a template creation screen for creating an adjustment condition template on a first terminal apparatus used by the adjustment initiator, and
the adjustment condition setting unit registers the adjustment condition template that can be repeatedly used for adjustment of time/dates of different assemblies and the access information corresponding to the adjustment condition template, in response to designation of the adjustment initiator for the template creation screen.

9. The time/date adjustment apparatus according to claim 1 or 2, wherein
the participant is the adjustment initiator themselves, or a belonging member belonging to an organization to which the adjustment initiator belongs.

10. The time/date adjustment apparatus according to claim 1 or 2, wherein
when a plurality of the participants are designated as the adjustment condition, the time/date adjustment unit refers to, in response to the adjustment partner performing access based on the access information, the schedule information of all of the plurality of the participants managed by the external system to extract the available time/dates common to all of the plurality of the participants satisfying the adjustment condition as the candidate time/dates.

11. The time/date adjustment apparatus according to claim 1 or 2, wherein
when a plurality of the participants are designated as the adjustment condition, the time/date adjustment unit refers to, in response to the adjustment partner performing access based on the access information, the schedule information of all of the plurality of the participants managed by the external system to extract the available time/dates of at least one of all of the plurality of the participants satisfying the adjustment condition as the candidate time/dates.

12. The time/date adjustment apparatus according to claim 1 or 2, wherein
the adjustment condition setting unit sets the adjustment condition including a site to be used for the assembly, in response to the input of the adjustment initiator,
when the adjustment partner performs access based on the access information, the time/date adjustment unit refers to the schedule information of each of the participant and the site managed by the external system to extract the available time/dates common to the available time/dates of the participant satisfying the adjustment condition and the available time/dates of the site on which the existing plans of the site are not present as the candidate time/dates,
the time/date adjustment unit causes the second terminal apparatus to display the time/date adjustment screen presenting the extracted candidate time/dates, and determines the assembly time/date out of the candidate time/dates in response to the selection operation of the adjustment partner for the time/date adjustment screen, and
the time/date adjustment unit registers the determined assembly time/date in the schedule information of each of the participant and the site managed by the external system.

13. A time/date adjustment method performed by a time/date adjustment apparatus, the time/date adjustment method comprising:
an adjustment condition setting step of setting an adjustment condition related to an assembly; and
a time/date adjustment step of adjusting an assembly time/date based on the adjustment condition, wherein
the adjustment condition setting step includes setting the adjustment condition including a participant and designation of an exclusion keyword in response to an input of an adjustment initiator,
the time/date adjustment step includes excluding an existing plan of which information related to the existing plan includes the exclusion keyword out of the existing plans of the participant in schedule information managed by an external system from plans that require participation, considering a rest of the existing plans as the plans that require participation, and determining time/dates on which the plans that require participation are not present as available time/dates of the participant,
when an adjustment partner performs access based on access information notified to the adjustment partner by the adjustment initiator, the time/date adjustment step includes referring to the schedule information of the participant managed by the external system to extract the available time/dates of the participant satisfying the adjustment condition as candidate time/dates,
the time/date adjustment step includes displaying a time/date adjustment screen presenting the extracted candidate time/dates on a second terminal apparatus used by the adjustment partner, and determining the assembly time/date out of the candidate time/dates in response to a selection operation of the adjustment partner for the time/date adjustment screen, and
the time/date adjustment step includes registering the determined assembly time/date in the schedule information of the participant managed by the external system.

14. A non-transitory computer-readable storage medium storing a program causing a computer to function as:
an adjustment condition setting unit configured to set an adjustment condition related to an assembly; and
a time/date adjustment unit configured to adjust an assembly time/date based on the adjustment condition, wherein
the adjustment condition setting unit sets the adjustment condition including a participant and designation of an exclusion keyword in response to an input of an adjustment initiator,
the time/date adjustment unit is configured to exclude an existing plan of which information related to the existing plan includes the exclusion keyword out of the existing plans of the participant in schedule information managed by an external system from plans that require participation, consider a rest of the existing plans as the plans that require participation, and determine time/dates on which the plans that require participation are not present as available time/dates of the participant,
when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates,
the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and
the time/date adjustment unit registers the determined assembly time/date in the schedule information of the participant managed by the external system.

15. A time/date adjustment method performed by a time/date adjustment apparatus, the time/date adjustment method comprising:
an adjustment condition setting step of setting an adjustment condition related to an assembly; and
a time/date adjustment step of adjusting an assembly time/date based on the adjustment condition, wherein
the adjustment condition setting step includes setting the adjustment condition including a participant and designation of an exclusion plan in response to an input of an adjustment initiator,
the time/date adjustment step includes excluding an existing plan designated as the exclusion plan by the adjustment initiator out of the existing plans of the participant in schedule information managed by an external system from plans that require participation, considering a rest of the existing plans as the plans that require participation, and determining time/dates on which the plans that require participation are not present as available time/dates of the participant,
when an adjustment partner performs access based on access information notified to the adjustment partner by the adjustment initiator, the time/date adjustment step includes referring to the schedule information of the participant managed by the external system to extract the available time/dates of the participant satisfying the adjustment condition as candidate time/dates,
the time/date adjustment step includes displaying a time/date adjustment screen presenting the extracted candidate time/dates on a second terminal apparatus used by the adjustment partner, and determining the assembly time/date out of the candidate time/dates in response to a selection operation of the adjustment partner for the time/date adjustment screen, and
the time/date adjustment step includes registering the determined assembly time/date in the schedule information of the participant managed by the external system.

16. A non-transitory computer-readable storage medium storing a program causing a computer to function as:
an adjustment condition setting unit configured to set an adjustment condition related to an assembly; and
a time/date adjustment unit configured to adjust an assembly time/date based on the adjustment condition, wherein
the adjustment condition setting unit sets the adjustment condition including a participant and designation of an exclusion plan in response to an input of an adjustment initiator,
the time/date adjustment unit is configured to exclude an existing plan designated as the exclusion plan by the adjustment initiator out of the existing plans of the participant in schedule information managed by an external system from plans that require participation, consider a rest of the existing plans as the plans that require participation, and determine time/dates on which the plans that require participation are not present as available time/dates of the participant,
when an adjustment partner performs access based on access information notified to the adjustment partner by the adjustment initiator, the time/date adjustment unit refers to the schedule information of the participant managed by the external system to extract the available time/dates of the participant satisfying the adjustment condition as candidate time/dates,
the time/date adjustment unit displays a time/date adjustment screen presenting the extracted candidate time/dates on a second terminal apparatus used by the adjustment partner, and determines the assembly time/date out of the candidate time/dates in response to a selection operation of the adjustment partner for the time/date adjustment screen, and
the time/date adjustment unit registers the determined assembly time/date in the schedule information of the participant managed by the external system.
